(19) United States
(12) Patent Application Publication
(10) Pub. No.: US 2022/0063662 A1
(43) Pub. Date: Mar. 3, 2022

(54) AUTONOMOUS DRIVING WITH SURFEL MAPS

(71) Applicant: Waymo LLC, Mountain View, CA (US)

(72) Inventors: Christoph Sprunk, Mountain View, CA (US); David Harrison Silver, San Carlos, CA (US); Carlos Hernandez Esteban, Kirkland, WA (US); Michael Montemerlo, Mountain View, CA (US); Peter Pawlowski, Menlo Park, CA (US); David Yonchar Margines, Sunnyvale, CA (US)

(21) Appl. No.: 17/003,827

(22) Filed: Aug. 26, 2020

(51) Int. Cl. B60W 60/00; G06K 9/62

(52) U.S. Cl. CPC B60W 60/0011; B60W 60/0027; G06K 9/6211; B60W 2420/42; B60W 2554/4029; B60W 2554/4041; B60W 2552/50

(57) ABSTRACT

Methods, systems, and apparatus, including computer programs encoded on computer storage media, for autonomous driving with surfel maps. In some implementations, a three-dimensional representation of a real-world environment is obtained. Each of the surfels can correspond to a respective point of plurality of points in a three-dimensional space of the real-world environment. Input sensor data is received from multiple sensors installed on the autonomous vehicle. A pedestrian is detected from the input sensor data. A determination is made that the pedestrian is located behind a barrier. A driving plan is updated based on determining that the pedestrian is located behind a barrier.

### BACKGROUND

Autonomous vehicles include self-driving cars, boats, and aircraft. Autonomous vehicles use a variety of on-board sensors in tandem with map representations of the environment in order to make control and navigation decisions.

Some vehicles use a two-dimensional or a 2.5-dimensional map to represent characteristics of the operating environment. A two-dimensional map associates each location, e.g., as given by latitude and longitude, with some properties, e.g., whether the location is a road, or a building, or an obstacle. A 2.5-dimensional map additionally associates a single elevation with each location. However, such 2.5-dimensional maps are problematic for representing three-dimensional features of an operating environment that might in reality have multiple elevations. For example, overpasses, tunnels, trees, and lamp posts all have multiple meaningful elevations within a single latitude/longitude location on a map.

One challenging aspect of autonomous vehicle planning is accounting for the inherently unpredictable actions of pedestrians, who may or may not obey local ordinance regarding crosswalks and jaywalking. Thus, a common problem is vehicles making numerous sudden stops when a pedestrian is detected in order to be on the safe side of a possible pedestrian encounter.

### SUMMARY

This specification describes how a vehicle, e.g. an autonomous or semi-autonomous vehicle, can use a surfel map to represent barriers in an environment, which allows the vehicle's planning system to make very accurate predictions about the possible or likely actions of pedestrians. This maintains the safety of the vehicle while also making the driving experience faster, smoother, and more natural.

In general, the surfel map can be used with sensor data to generate a prediction for a state of an environment surrounding the vehicle. A system on-board the vehicle can obtain the surfel data, e.g. surfel data that has been generated by one or more vehicles navigating through the environment at respective previous time points, from a server system and the sensor data from one or more sensors on-board the vehicle. The system can then combine the surfel data and the sensor data to generate a prediction for one or more objects in the environment.

The system need not treat the existing surfel data or the new sensor data as a ground-truth representation of the environment. Instead, the system can assign a particular level of uncertainty to both the surfel data and the sensor data, and combine them to generate a representation of the environment that is typically more accurate than either the surfel data or the sensor data in isolation.

Particular embodiments of the subject matter described in this specification can be implemented so as to realize one or more of the following advantages.

Some existing systems use a 2.5-dimensional system to represent an environment, which limits the representation to a single element having a particular altitude for each (latitude, longitude) coordinate in the environment. Using techniques described in this specification, a system can instead leverage a three-dimensional surfel map to make autonomous driving decisions. The three-dimensional surfel map allows multiple different elements at respective altitudes for each (latitude, longitude) coordinate in the environment, yielding a more accurate and flexible representation of the environment.

Some existing systems rely entirely on existing representations of the world, generated offline using sensor data generated at previous time points, to navigate through a particular environment. These systems can be unreliable, because the state of the environment might have changed since the representation was generated offline. Some other existing systems rely entirely on sensor data generated by the vehicle at the current time point to navigate through a particular environment. These systems can be inefficient, because they fail to leverage existing knowledge about the environment that the vehicle or other vehicles have gathered at previous time points. Using techniques described in this specification, an on-board system can combine an existing surfel map and online sensor data to generate a prediction for the state of the environment. The existing surfel data allows the system to get a jump-start on the prediction and plan ahead for regions that are not yet in the range of the sensors of the vehicle, while the sensor data allows the system to be agile to changing conditions in the environment.

Particular embodiments of the subject matter described in this specification can be implemented so as to realize one or more of the following advantages. Using a surfel representation to combine the existing data and the new sensor data can be particularly efficient. Using techniques described in this specification, a system can quickly integrate new sensor data with the data in the surfel map to generate a representation that is also a surfel map. This process is especially time- and memory-efficient because surfels require relatively little bookkeeping, as each surfel is an independent entity. Existing systems that rely, e.g., on a 3D mesh cannot integrate sensor data as seamlessly because if the system moves one particular vertex of the mesh, then the entire mesh is affected; different vertices might cross over each other, yielding a crinkled mesh that that must be untangled.

Moreover, numerous advantages can be realized by using a surfel representation to represent barriers in a real-world environment. Notably, using the surfel representation with representations of barriers can be used to improve autonomous and/or semi-autonomous navigation, reduce wear on vehicles, reduce energy consumption, and improve safety of passengers and pedestrians. These techniques are made possible in part because the richness of a surfel map provides the ability to detect the size, height, shape and location of barriers with very high confidence in a way that isn't possible with two-dimensional or 2.5-dimensional maps. For example, by referring to a surfel map with a representation of a road barrier, an onboard navigation system can determine with high confidence that a barrier is likely to prevent one or more pedestrians from entering a roadway. If the navigation system determines with sufficient confidence that no pedestrians are likely to enter the roadway in a path of travel of the corresponding vehicle, the vehicle, as a result, can avoid unnecessary braking, swerving, lane changes, hard accelerations, etc. Each of these actions would otherwise increase the risk of an accident, harm to passengers of the vehicle, harm to pedestrians, damage to the vehicle, damage to other vehicles, other passengers, etc. In addition, by avoiding these evasive maneuvers when unnecessary, energy consumption, brake wear, tire wear, engine wear, and other mechanical wear on the vehicle can be reduced.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2A is an illustration of an example environment.

FIG. 2B is an illustration of an example surfel map of the environment of FIG. 2A.

FIG. 3 is a flow diagram of an example process for combining surfel data and sensor data.

FIG. 4 is a diagram illustrating an example environment.

FIG. 5A is a diagram illustrating an example visible view of an environment.

FIG. 5B is a diagram illustrating an example 2.5-dimensional map of the environment.

FIG. 5C is a diagram illustrating an example surfel map of the environment.

FIG. 6 is a flow diagram of an example process for adjusting navigation using a surfel map.

### DETAILED DESCRIPTION

This specification describes how a vehicle, e.g., an autonomous or semi-autonomous vehicle, can use a surfel map to make autonomous driving decisions taking into consideration the likely actions of pedestrians detected near barriers represented in the surfel map.

In this specification, a surfel is data that represents a two-dimensional surface that corresponds to a particular three-dimensional coordinate system in an environment. A surfel includes data representing a position and an orientation of the two-dimensional surface in the three-dimensional coordinate system. The position and orientation of a surfel can be defined by a corresponding set of coordinates. For example, a surfel can be defined by spatial coordinates, e.g., (x,y,z) defining a particular position in a three-dimensional coordinate system, and orientation coordinates, e.g., (pitch, yaw, roll) defining a particular orientation of the surface at the particular position. As another example, a surfel can be defined by spatial coordinates that define the particular position in a three-dimensional coordinate system and a normal vector, e.g., a vector with a magnitude of 1, that defines the orientation of the surface at the particular position. The location of a surfel can be represented in any appropriate coordinate system. In some implementations, a system can divide the environment being modeled to include volume elements (voxels) and generate at most one surfel for each voxel in the environment that includes a detected object. In some other implementations, a system can divide the environment being modeled into voxels, where each voxel can include multiple surfels; this can allow each voxel to represent complex surfaces more accurately.

A surfel can also optionally include size and shape parameters, although often all surfels in a surfel map have the same size and shape. A surfel can have any appropriate shape. For example, a surfel can be a square, a rectangle, an ellipsoid, or a two-dimensional disc, to name just a few examples. In some implementations, different surfels in a surfel map can have different sizes, so that a surfel map can have varying levels of granularity depending on the environment described by the surfel map; e.g., large surfels can corresponds to large, flat areas of the environment, while smaller surfels can represent areas of the environment that require higher detail.

In this specification, a surfel map is a collection of surfels that each correspond to a respective location in the same environment. The surfels in a surfel map collectively represent the surface detections of objects in the environment. In some implementations, each surfel in a surfel map can have additional data associated with it, e.g., one or more labels describing the surface or object characterized by the surfel. As a particular example, if a surfel map represents a portion of a city block, then each surfel in the surfel map can have a semantic label identifying the object that is being partially characterized by the surfel, e.g., “streetlight,” “stop sign,” “mailbox,” etc.

A surfel map can characterize a real-world environment, e.g., a particular portion of a city block in the real world, or a simulated environment, e.g., a virtual intersection that is used to simulate autonomous driving decisions to train one or more machine learning models. As a particular example, a surfel map characterizing a real-world environment can be generated using sensor data that has been captured by sensors operating in the real-world environment, e.g., sensors on-board a vehicle navigating through the environment. In some implementations, an environment can be partitioned into multiple three-dimensional volumes, e.g., a three-dimensional grid of cubes of equal size, and a surfel map characterizing the environment can have at most one surfel corresponding to each volume.

After the surfel map has been generated, e.g., by combining sensor data gathered by multiple vehicles across multiple trips through the real-world, one or more systems on-board a vehicle can receive the generated surfel map. Then, when navigating through a location in the real world that is represented by the surfel map, the vehicle can process the surfel map along with real-time sensor measurements of the environment in order to make better driving decisions than if the vehicle were to rely on the real-time sensor measurements alone.

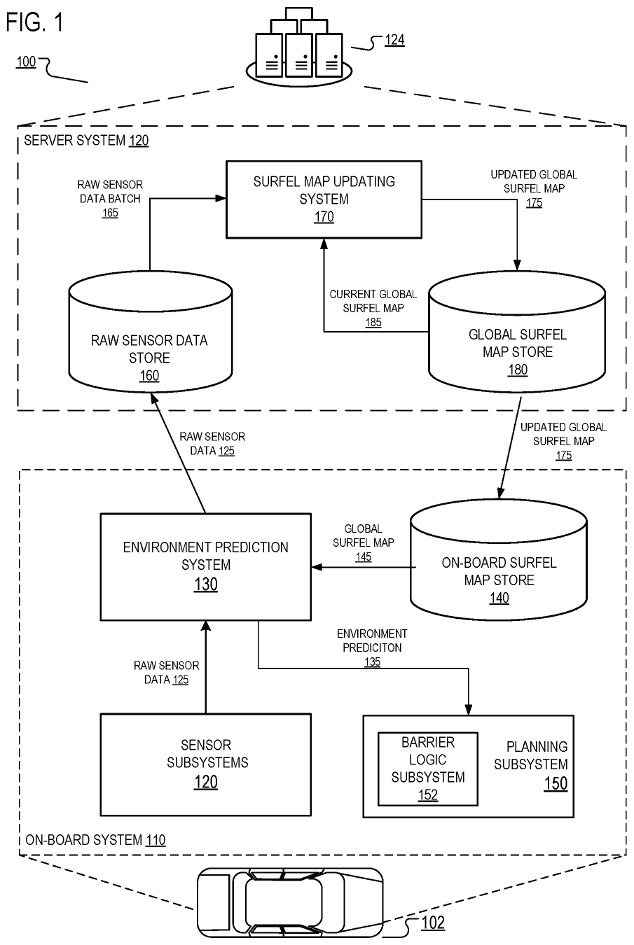

FIG. 1 is a diagram of an example system 100. The system 100 can include multiple vehicles, each with a respective on-board system. For simplicity, a single vehicle 102 and its on-board system 110 is depicted in FIG. 1. The system 100 also includes a server system 120 which every vehicle in the system 100 can access.

The vehicle 102 in FIG. 1 is illustrated as an automobile, but the on-board system 102 can be located on-board any appropriate vehicle type. The vehicle 102 can be a fully autonomous vehicle that determines and executes fully-autonomous driving decisions in order to navigate through an environment. The vehicle 102 can also be a semi-autonomous vehicle that uses predictions to aid a human driver. For example, the vehicle 102 can autonomously apply the brakes if a prediction indicates that a human driver is about to collide with an object in the environment, e.g., an object or another vehicle represented in a surfel map. The on-board system 110 includes one or more sensor subsystems 120. The sensor subsystems 120 include a combination of components that receive reflections of electromagnetic radiation, e.g., lidar systems that detect reflections of laser light, radar systems that detect reflections of radio waves, and camera systems that detect reflections of visible light.

The sensor data generated by a given sensor generally indicates a distance, a direction, and an intensity of reflected radiation. For example, a sensor can transmit one or more pulses of electromagnetic radiation in a particular direction and can measure the intensity of any reflections as well as the time that the reflection was received. A distance can be computed by determining how long it took between a pulse and its corresponding reflection. The sensor can continually sweep a particular space in angle, azimuth, or both. Sweeping in azimuth, for example, can allow a sensor to detect multiple objects along the same line of sight.

The sensor subsystems 120 or other components of the vehicle 102 can also classify groups of one or more raw sensor measurements from one or more sensors as being measures of an object of a particular type. A group of sensor measurements can be represented in any of a variety of ways, depending on the kinds of sensor measurements that are being captured. For example, each group of raw laser sensor measurements can be represented as a three-dimensional point cloud, with each point having an intensity and a position. In some implementations, the position is represented as a range and elevation pair. Each group of camera sensor measurements can be represented as an image patch, e.g., an RGB image patch.

Once the sensor subsystems 120 classify one or more groups of raw sensor measurements as being measures of a respective object of a particular type, the sensor subsystems 120 can compile the raw sensor measurements into a set of raw sensor data 125, and send the raw data 125 to an environment prediction system 130.

The on-board system 110 also includes an on-board surfel map store 140 that stores a global surfel map 145 of the real-world. The global surfel map 145 is an existing surfel map that has been generated by combining sensor data captured by multiple vehicles navigating through the real world.

Generally, every vehicle in the system 100 can use the same global surfel map 145. In some cases, different vehicles in the system 100 can use different global surfel maps 145, e.g., when some vehicles have not yet obtained an updated version of the global surfel map 145 from the server system 120.

Each surfel in the global surfel map 145 can have associated data that encodes multiple classes of semantic information for the surfel. For example, for each of the classes of semantic information, the surfel map can have one or more labels characterizing a prediction for the surfel corresponding to the class, where each label has a corresponding probability. As a particular example, each surfel can have multiple labels, with associated probabilities, predicting the type of the object characterized by the surfel, e.g., “pole” with probability 0.8, “street sign” with probability 0.15, and “fire hydrant” with probability 0.05.

The environment prediction system 130 can receive the global surfel map 145 and combine it with the raw sensor data 125 to generate an environment prediction 135. The environment prediction 135 includes data that characterizes a prediction for the current state of the environment, including predictions for an object or surface at one or more locations in the environment.

The raw sensor data 125 might show that the environment through which the vehicle 102 is navigating has changed. In some cases, the changes might be large and discontinuous, e.g., if a new building has been constructed or a road has been closed for construction since the last time the portion of the global surfel map 145 corresponding to the environment has been updated. In some other cases, the changes might be small and continuous, e.g., if a bush grew by an inch or a leaning pole increased its tilt. In either case, the raw sensor data 125 can capture these changes to the world, and the environment prediction system 130 can use the raw sensor data to update the data characterizing the environment stored in the global surfel map 145 to reflect these changes in the environment prediction 135.

For one or more objects represented in the global surfel map 145, the environment prediction system 130 can use the raw sensor data 125 to determine a probability that the object is currently in the environment. In some implementations, the environment prediction system 130 can use a Bayesian model to generate the predictions of which objects are currently in the environment, where the data in the global surfel map 145 is treated as a prior distribution for the state of the environment, and the raw sensor data 125 is an observation of the environment. The environment prediction system 130 can perform a Bayesian update to generate a posterior belief of the state of the environment, and include this posterior belief in the environment prediction 135. In some implementations, the raw sensor data 125 also has a probability distribution for each object detected by the sensor subsystem 120 describing a confidence that the object is in the environment at the corresponding location; in some other implementations, the raw sensor data 125 includes detected objects with no corresponding probability distribution.

If the global surfel map 145 includes a representation of a particular object, and the raw sensor data 125 includes a strong detection of the particular object in the same location in the environment, then the environment prediction system 135 can include a prediction that the object is in the location with high probability, e.g., 0.95 or 0.99. For example, the environment prediction system 130 can use the raw sensor data 125 that includes, for example, laser data corresponding to a road barrier, e.g., strongly indicating that a barrier is present) and the global surfel map 145 that may include a representation of the barrier 104 to determine a probability that the barrier is currently in an environment that the vehicle 102 is traveling in. The environment prediction system 135 may assign a high probability of 0.98, indicating that there is a high confidence of the presence of the barrier.

However, if the global surfel map 145 does not include the particular object, but the raw sensor data 125 includes a strong detection of the particular object in the environment, then the environment prediction 135 might include a weak prediction that the object is in the location indicated by the raw sensor data 125, e.g., predict that the object is at the location with probability of 0.5 or 0.6. If the global surfel map 145 does include the particular object, but the raw sensor data 125 does not include a detection of the object at the corresponding location, or includes only a weak detection of the object, then the environment prediction 135 might include a prediction that has moderate uncertainty, e.g., assigning a 0.7 or 0.8 probability that the object is present.

That is, the environment prediction system 130 might assign more confidence to the correctness of the global surfel map 145 than to the correctness of the raw sensor data 125. In some other implementations, the environment prediction system 130 might assign the same or more confidence to the correctness of the sensor data 125 than to the correctness of the global surfel map 145. In either case, the environment prediction system 130 does not treat the raw sensor data 125 or the global surfel map 145 as a ground-truth, but rather associates uncertainty with both in order to combine them. Approaching each input in a probabilistic manner can generate a more accurate environment prediction 135, as the raw sensor data 125 might have errors, e.g., if the sensors in the sensor subsystems 120 are miscalibrated, and the global surfel map 145 might have errors, e.g., if the state of the world has changed.

In some implementations, the environment prediction 135 can also include a prediction for each class of semantic information for each object in the environment. For example, the environment prediction system 130 can use a Bayesian model to update the associated data of each surfel in the global surfel map 145 using the raw sensor data 125 in order to generate a prediction for each semantic class and for each object in the environment. For each particular object represented in the global surfel map 145, the environment prediction system 130 can use the existing labels of semantic information of the surfels corresponding to the particular object as a prior distribution for the true labels for the particular object. The environment prediction system 130 can then update each prior using the raw sensor data 125 to generate posterior labels and associated probabilities for each class of semantic information for the particular object. In some such implementations, the raw sensor data 125 also has a probability distribution of labels for each semantic class for each object detected by the sensor subsystem 120; in some other such implementations, the raw sensor data 125 has a single label for each semantic class for each detected object.

Continuing the previous particular example, where a particular surfel characterizes a pole with probability 0.8, a street sign with probability 0.15, and fire hydrant with probability 0.05, if the sensor subsystems 120 detect a pole at the same location in the environment with high probability, then the Bayesian update performed by the environment prediction system 130 might generate new labels indicating that the object is a pole with probability 0.85, a street sign with probability 0.12, and fire hydrant with probability 0.03. The new labels and associated probabilities for the object are added to the environment prediction 135.

Similarly, where a particular surfel characterizes a barrier with probability 0.92, and a street sign with probability 0.08, if the sensor subsystems 120 detect a barrier at the same location in the environment with high probability, then the Bayesian update performed by the environment prediction system 130 might generate new labels indicating that the object is a barrier with probability 0.95, and a street sign with probability 0.05. The new labels and associated probabilities for the object are added to the environment prediction 135

The environment prediction system 130 can provide the environment prediction 135 to a planning subsystem 150, which can use the environment prediction 130 to make autonomous driving decisions, e.g., generating a planned trajectory for the vehicle 102 through the environment.

The planning subsystem 150 can make use of a barrier logic subsystem 152 to determine whether a barrier is likely to prevent detected pedestrians from entering the road. As an example, the barrier logic subsystem can determine that a barrier is sufficiently likely to prevent a detected pedestrian from entering a roadway on which the vehicle 102 is traveling or from crossing a previously determined path for the vehicle 102. The planning subsystem 150 can thus determine that no changes should be made to planned path for the vehicle 102, despite the presence of detected pedestrians.

The environment prediction system 130 can also provide the raw sensor data 125 to a raw sensor data store 160 located in the server system 120.

The server system 120 is typically hosted within a data center 124, which can be a distributed computing system having hundreds or thousands of computers in one or more locations.

The server system 120 includes a raw sensor data store 160 that stores raw sensor data generated by respective vehicles navigating through the real world. As each vehicle captures new sensor data characterizing locations in the real world, each vehicle can provide the sensor data to the server system 120. The server system 120 can then use the sensor data to update the global surfel map that every vehicle in the system 100 uses. That is, when a particular vehicle discovers that the real world has changed in some way, e.g., construction has started at a particular intersection or a street sign has been taken down, the vehicle can provide sensor data to the server system 120 so that the rest of the vehicles in the system 100 can be informed of the change.

The server system 120 also includes a global surfel map store 180 that maintains the current version of the global surfel map 185.

A surfel map updating system 170, also hosted in the server system 120, can obtain the current global surfel map 185 and a batch of raw sensor data 165 from the raw sensor data store 160 in order to generate an updated global surfel map 175. In some implementations, the surfel map updating system 170 updates the global surfel map at regular time intervals, e.g., once per hour or once per day, obtaining a batch of all of the raw sensor data 165 that has been added to the raw sensor data store 160 since the last update. In some other implementations, the surfel map updating system 170 updates the global surfel map whenever a new raw sensor data 125 is received by the raw sensor data store 160.

In some implementations, the surfel map updating system 170 generates the updated global surfel map 175 in a probabilistic way.

In some such implementations, for each measurement in the batch of raw sensor data 165, the surfel map updating system 170 can determine a surfel in the current global surfel map 185 corresponding to the location in the environment of the measurement, and combine the measurement with the determined surfel. For example, the surfel map updating system 170 can use a Bayesian model to update the associated data of a surfel using a new measurement, treating the associated data of the surfel in the current global surfel map 185 as a prior distribution. The surfel map updating system 170 can then update the prior using the measurement to generate posterior distribution for the corresponding location. This posterior distribution is then included in the associated data of the corresponding surfel in the updated global surfel map 175.

If there is not currently a surfel at the location of a new measurement, then the surfel map updating system 170 can generate a new surfel according to the measurement.

In some such implementations, the surfel map updating system 170 can also update each surfel in the current global surfel map 185 that did not have a corresponding new measurement in the batch of raw sensor data 165 to reflect a lower certainty that an object is at the location corresponding to the surfel. In some cases, e.g., if the batch of raw sensor data 165 indicates a high confidence that there is not an object at the corresponding location, the surfel map updating system 170 can remove the surfel from the updated global surfel map 175 altogether. In some other cases, e.g., when the current global surfel map 185 has a high confidence that the object characterized by the surfel is permanent and therefore that the lack of a measurement of the object in the batch of raw sensor data 165 might be an error, the surfel map updating system 170 might keep the surfel in the updated global surfel map 175 but decrease the confidence of the updated global surfel map 175 that an object is at the corresponding location.

After generating the updated global surfel map 175, the surfel map updating system 170 can store it in the global surfel map store 180, replacing the stale global surfel map 185. Each vehicle in the system 100 can then obtain the updated global surfel map 175 from the server system 120, e.g., through a wired or wireless connection, replacing the stale version with the retrieved updated global surfel map 175 in the on-board surfel map store 140. In some implementations, each vehicle in the system 100 retrieves an updated global surfel map 175 whenever the global surfel map is updated and the vehicle is connected to the server system 120 through a wired or wireless connection. In some other implementations, each vehicle in the system 100 retrieves the most recent updated global surfel map 175 at regular time intervals, e.g., once per day or once per hour.

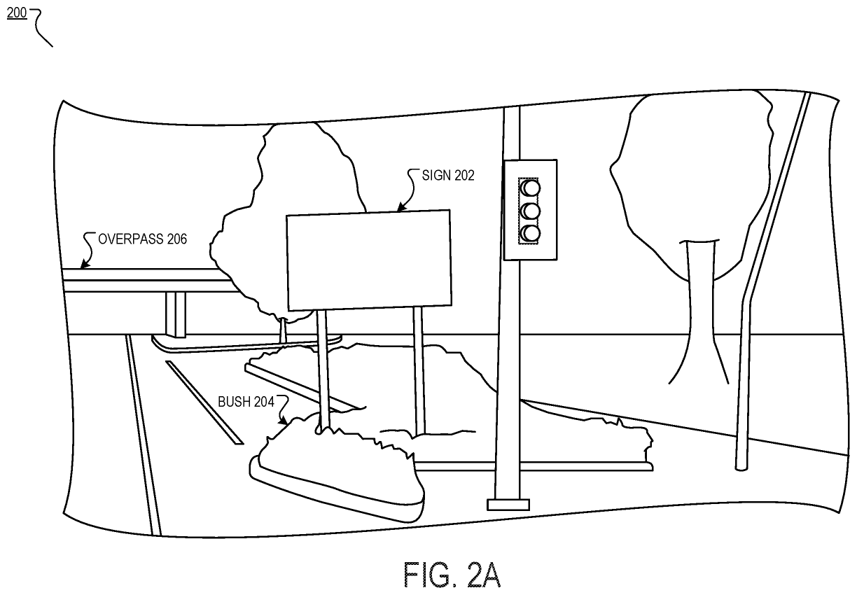

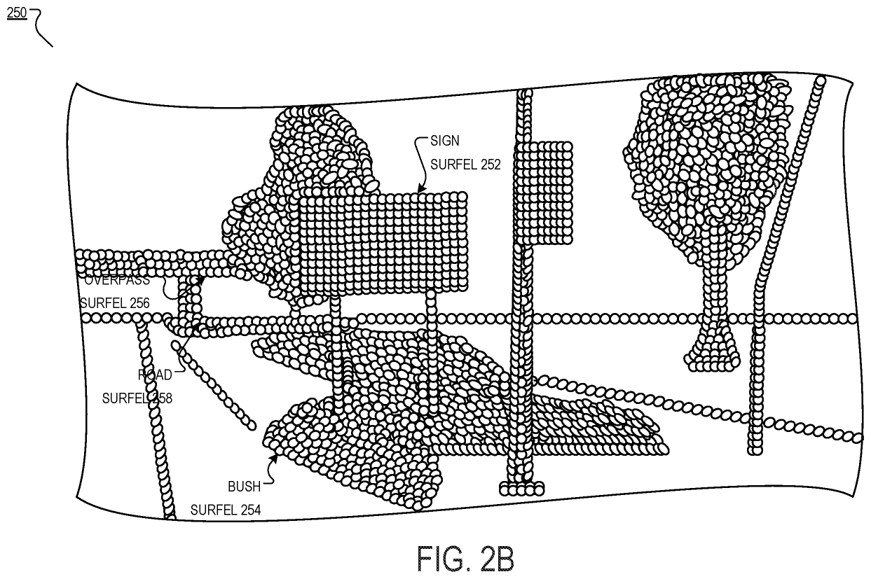

FIG. 2A is an illustration of an example environment 200. The environment 200 is depicted from the point of view of a sensor on-board a vehicle navigating through the environment 200. The environment 200 includes a sign 202, a bush 204, and an overpass 206. The on-board system 110 described in FIG. 1 might classify the bush 204 as a barrier or a barrier with a bush label.

FIG. 2B is an illustration of an example surfel map 250 of the environment 200 of FIG. 2A.

Each surfel in the example surfel map 250 is represented by a disk, and defined by three coordinates (latitude, longitude, altitude), that identify a position of the surfel in a common coordinate system of the environment 200 and by a normal vector that identifies an orientation of the surfel. For example, each voxel can be defined to be the disk that extends some radius, e.g., 1, 10, 25, or 100 centimeters, around the (latitude, longitude, altitude) coordinate. In some other implementations, the surfels can be represented as other two-dimensional shapes, e.g. ellipsoids or squares.

The environment 200 is partitioned into a grid of equal-sized voxels. Each voxel in the grid of the environment 200 can contain at most one surfel, where, e.g., the (latitude, longitude, altitude) coordinate of each surfel defines the voxel that the surfel occupies. That is, if there is a surface of an object at the location in the environment corresponding to a voxel, then there can be a surfel characterizing the surface in the voxel; if there is not a surface of an object at the location, then the voxel is empty. In some other implementations, a single surfel map can contain surfels of various different sizes that are not organized within a fixed spatial grid.

Each surfel in the surfel map 250 has associated data characterizing semantic information for the surfel. For example, as discussed above, for each of multiple classes of semantic information, the surfel map can have one or more labels characterizing a prediction for the surfel corresponding to the class, where each label has a corresponding probability. As a particular example, each surfel can have multiple labels, with associated probabilities, predicting the type of the object characterized by the surfel. As another particular example, each surfel can have multiple labels, with associated probabilities, predicting the permanence of the object characterized by the surfel; for example, a “permanent” label might have a high associated probability for surfels characterizing buildings, while the “permanent” label might have a high probability for surfels characterizing vegetation. Other classes of semantic information can include a color, reflectivity, or opacity of the object characterized by the surfel.

For example, the surfel map 250 includes a sign surfel 252 that characterizes a portion of the surface of the sign 202 depicted in FIG. 2A. The sign surfel 252 might have labels predicted that the type of the object characterized by the sign surfel 252 is “sign” with probability 0.9 and “billboard” with probability 0.1. Because street signs are relatively permanent objects, the “permanent” label for the sign surfel 252 might be 0.95. The sign surfel 252 might have color labels predicting the color of the sign 202 to be “green” with probability 0.8 and “blue” with probability 0.2. Because the sign 202 is completely opaque and reflects some light, an opacity label of the sign surfel 252 might predict that the sign is “opaque” with probability 0.99 and a reflectivity label of the sign surfel 252 might predict that the sign is “reflective” with probability 0.6.

As another example, the surfel map 250 includes a bush surfel 254 that characterizes a portion of the bush 204 depicted in FIG. 2A. The bush surfel 254 may be considered a barrier surfel when the bush is considered a barrier. The bush surfel 254 might have labels predicted that the type of the object characterized by the bush surfel 254 is “barrier” or “bush” with probability 0.75 and “tree” with probability 0.25. Because bushes can grow, be trimmed, and die with relative frequency, the “permanent” label for the bush surfel 254 might be 0.2. The bush surfel 254 might have color labels predicting the color of the bush 204 to be “green” with probability 0.7 and “yellow” with probability 0.3. Because the bush 204 is not completely opaque and does not reflect a lot of light, an opacity label of the bush surfel 254 might predict that the sign is “opaque” with probability 0.7 and a reflectivity label of the sign surfel 252 might predict that the sign is “reflective” with probability 0.4.

Note that, for any latitude and longitude in the environment 200, i.e., for any given (latitude, longitude) position in a plane running parallel to the ground of the environment 200, the surfel map 250 can include multiple different surfels each corresponding to a different altitude in the environment 200, as defined by the altitude coordinate of the surfel. This represents a distinction between some existing techniques that are “2.5-dimensional,” i.e., techniques that only allow a map to contain a single point at a particular altitude for any given latitude and longitude in a three-dimensional map of the environment. These existing techniques can sometimes fail when an environment has multiple objects at respective altitudes at the same latitude and longitude in the environment. For example, such existing techniques would be unable to capture both the overpass 206 in the environment 200 and the road underneath the overpass 205. The surfel map, on the other hand, is able to represent both the overpass 206 and the road underneath the overpass 206, e.g., with an overpass surfel 256 and a road surfel 258 that have the same latitude coordinate and longitude coordinate but a different altitude coordinate.

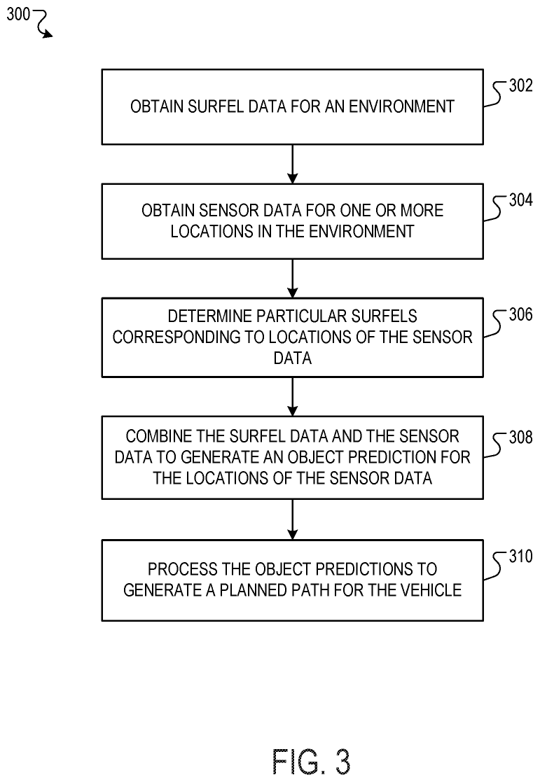

FIG. 3 is a flow diagram of an example process 300 for combining surfel data and sensor data. For convenience, the process 300 will be described as being performed by a system of one or more computers located in one or more locations. For example, an environment prediction system, e.g., the environment prediction system 130 depicted in FIG. 1, appropriately programmed in accordance with this specification, can perform the process 300.

The system obtains surfel data for an environment (step 302). The surfel data includes multiple surfels that each correspond to a respective different location in the environment. Each surfel in the surfel data can also have associated data. The associated data can include an certainty measure that characterizes a likelihood that the surface represented by the surfel is at the respective location of the surfel in the environment. That is, the certainty measure is a measure of how confident the system is that the surfel represents a surface that is actually in the environment at the current time point. For example, a surfel in the surfel map that represents a surface of a concrete barrier might have a relatively high certainty measure, because it is unlikely that the concrete barrier was removed between the time point at which the surfel map was created and the current time point. As another example, a surfel in the surfel map that represents a surface of a political campaign yard sign might have a relatively low certainty measure, because political campaign yard signs are usually temporary and therefore it is relatively likely that the yard sign has been removed between the time point at which the surfel map was created and the current time point.

The associated data of each surfel can also include a respective class prediction for each of one or more classes of semantic information for the surface represented by the surfel. In some implementations, the surfel data is represented using a voxel grid, where each surfel in the surfel data corresponds to a different voxel in the voxel grid.

The system obtains sensor data for one or more locations in the environment (step 304). The sensor data has been captured by one or more sensors of a vehicle navigating in the environment, e.g., the sensor subsystems 120 of the vehicle 102 depicted in FIG. 1.

In some implementations, the surfel data has been generated from data captured by one or more vehicles navigating through the environment at respective previous time points, e.g., the same vehicle that captured the sensor data and/or other vehicles.

The system determines one or more particular surfels corresponding to respective locations of the sensor data (step 306). For example, for each measurement in the sensor data, the system can select a particular surfel that corresponds to the same location as the measurement, if one exists in the surfel data. For example, if laser data indicates that an object is three meters away in a particular direction, the system can refer to a surfel map to try and identify the corresponding surfel. That is, the system can use the surfel map to determine that a surfel that is substantially three meters away in substantially the same direction is labelled as part of a road barrier.

The system combines the surfel data and the sensor data to generate an object prediction for each of the one or more locations of the sensor data (step 308). The object prediction for a particular location in the environment can include an updated certainty measure that characterizes likelihood that there is a surface of an object at the particular location.

In some implementations, the system performs a Bayesian update to generate the object prediction from the surfel data and sensor data. That is, the system can, for each location, determine that the associated data of the surfel corresponding to the location is a prior distribution for the object prediction, and update the associated data using the sensor data to generate the object prediction as the posterior distribution.

As a particular example, for each class of information in the surfel data to be updated, including the object prediction and/or one or more classes of semantic information, the system can update the probability associated with the class of information using Bayes' theorem:

$$P ( H \vert E ) = \frac{P ( E \vert H )}{P ( E )} \cdot P ( H ) ,$$

where H is the class of information (e.g., whether the object at the location is vegetation) and E is the sensor data. Here, P(H) is the prior probability corresponding to the class of information in the surfel data, and P(E|H) is probability of the sensors producing that particular sensor data given that the class of information is true. Thus, P(H|E) the posterior probability of the for the class of information. In some implementations, the system can execute this computation independently for each class of information.

For example, the surfel data might indicate a low likelihood that there is a surface of an object at the particular location; e.g., there may not be a surfel in the surfel data that corresponds to the particular location, or there may be a surfel in the surfel data that corresponds to the particular location that has a low certainty measure, indicating a low confidence that there is a surface at the particular location. The sensor data, on the other hand, might indicate a high likelihood that there is a surface of an object at the particular location, e.g., if the sensor data includes a strong detection of an object at the particular location.

In some such cases, the generated object prediction for the particular location might indicate a high likelihood that there is a temporary object at the particular location, e.g., debris on the road or a trash can moved into the street. As a particular example, the object prediction might include a high uncertainty score, indicating a high likelihood that there is an object at the location, and a high ‘temporary’ class score corresponding to a ‘temporary’ semantic label, indicating a high likelihood that the object is temporary. In some other such cases, the generated object prediction for the particular location might indicate a low likelihood that there is an object at the particular location, because the system might assign a higher confidence to the surfel data than to the sensor data. That is, the system might determine with a high likelihood that the sensors identified an object at the particular location in error. In some other such cases, the generated object prediction for the particular location might indicate a high likelihood that there is an object at the particular location, because the system might assign a higher confidence to the sensor data than the surfel data. That is, the system might determine with a high likelihood that the surfel data is stale, i.e., that the surfel data reflects a state of the environment at a previous time point but does not reflect the state of the environment at the current time point.

As another example, the surfel data might indicate a high likelihood that there is a surface of an object at the particular location; e.g., there may be a surfel in the surfel data that corresponds to the particular location that has a high certainty measure. The sensor data, on the other hand, might indicate a low likelihood that there is a surface of an object at the particular location, e.g., if the sensor data does not include an detection, or only includes a weak detection, of an object at the particular location.

In some such cases, the generated object prediction for the particular location might indicate a high likelihood that there is an object at the particular location, but that it is occluded from the sensors of the vehicle. As a particular example, if there it is precipitating in the environment at the current time point, the sensors of the vehicle might only measure a weak detection of an object at the limits of the range of the sensors. In some other such cases, the generated object prediction for the location might indicate a high likelihood that there is a reflective object at the location. When an object is reflective, a sensor that measures reflected light, e.g., a LIDAR sensor, can fail to measure a detection of the object and instead measure a detection of a different object in the environment whose reflection is captured off of the reflective object, e.g., a sensor might observe a tree reflected off a window instead of observing the window itself. As a particular example, the object prediction might include a high uncertainty score, indicating a high likelihood that there is an object at the location, and a high ‘reflective’ class score corresponding to a ‘reflectivity semantic label, indicating a high likelihood that the object is reflective. In some other such cases, the generated object prediction for the location might indicate a high likelihood that there is a transparent or semi-transparent object at the location. When an object is transparent, a sensor can fail to measure a detection of the object and instead measure a detection of a different object that is behind the transparent object. As a particular example, the object prediction might include a high uncertainty score, indicating a high likelihood that there is an object at the location, and a low ‘opaque’ class score corresponding to an ‘opacity’ semantic label, indicating a high likelihood that the object is transparent.

As another example, the surfel data and the sensor data might “agree.” That is, they might both indicate a high likelihood that there is an object at a particular location, or they might both indicate that there is a low likelihood that there is an object at the particular location. In these examples, the object prediction for the particular location can correspond to the agreed-upon state of the world.

In some implementations, the system can use the class predictions for classes of semantic information in the surfel data to generate the object predictions. For example, the system can retrieve the labels previously assigned to an identified surfel that corresponds with a detected object location. The label may indicate that the object is a barrier with 0.91 confidence, and a street sign with 0.09 confidence.

In some implementations, the generated object prediction for each location in the environment also includes an updated class prediction for each of the classes of semantic information that are represented in the surfel data. As a particular example, if a surfel is labeled as “asphalt” with a high probability, and the sensor data captures a measurement directly above the surfel, then the system might determine that the measurement characterizes another object with high probability. On the other hand, if the surfel is labeled as “hedge” with high probability, and the sensor data captures a measurement directly above the surfel, then the system might determine that the measurement characterizes the same hedge, i.e., that the hedge has grown.

In some implementations, the system can obtain multiple sets of sensor data corresponding to respective iterations of the sensors of the vehicle (e.g., spins of the sensor). In some such implementations, the system can execute an update for each set of sensor data in a streaming fashion, i.e., executing an independent update sequentially for each set of sensor data. In some other implementations, the system can use a voting algorithm to execute a single update to the surfel data.

In some implementations, the system can use the surfel data and the sensor data to determine that the object is a barrier and is sufficient to prevent one or more objects from entering a particular road. For example, the on-board system 110 can use the sensor data to verify the dimensions of a barrier and/or a material of a barrier. Based on this information, the on-board system 110 may determine that this barrier is sufficiently likely (greater than 90%, 95%, 97%, etc.) to prevent any pedestrians from entering the roadway, but that large animals may still pose an unacceptable risk (e.g., barrier is unlikely to prevent more than 80%, 85%, 90%, etc. of large animals from entering the roadway).

In some implementations, the system uses the sensor data to identify animate objects in the environment. For example, the on-board system 110 may use LIDAR and image data to identify persons and animals in the environment where the vehicle 102 is driving. The on-board system 110 may track these objects.

In some implementations, generating an object prediction for the locations of the sensor data includes generating a prediction using the surfel data and the sensor data that an animate object will not enter a roadway or otherwise cross a path of travel for the vehicle. For example, continuing with the previous example, the on-board system 110 may determine based on its previous determinations that a barrier is sufficiently likely to prevent a detected pedestrian from entering the roadway that the vehicle 102 is traveling on.

After generating the object predictions, the system can process the object predictions to generate a planned path for the vehicle (step 310). For example, the system can provide the object predictions to a planning subsystem of the system, e.g., the planning subsystem 150 depicted in FIG. 1, and the planning subsystem can generate the planned path. The system can generate the planned path in order to avoid obstacles that are represented in the object predictions. The planning subsystem can also use the class predictions for one or more of the classes of semantic information to make autonomous driving decisions, e.g., by avoiding portions of the road surface that have a likelihood of being icy.

As a particular example, the vehicle may be on a first street and approaching a second street, and a planned path of the vehicle instructs the vehicle to make a right turn onto the second street. The surfel data includes surfels representing a hedge on the left side of the first street, such that the hedge obstructs the sensors of the vehicle from being able to observe oncoming traffic moving towards the vehicle on the second street. Using this existing surfel data, before the vehicle arrives at the second street the planning subsystem might have determined to take a particular position on the first street in order to be able observe the oncoming traffic around the hedge. However, as the vehicle approaches the second street, the sensors capture sensor data that indicates that the hedge has grown. The system can combine the surfel data and the sensor data to generate a new object prediction for the hedge that represents its current dimensions. The planning subsystem can process the generated object prediction to update the planned path so that the vehicle can take a different particular position on the first street in order to be able to observe the oncoming traffic around the hedge.

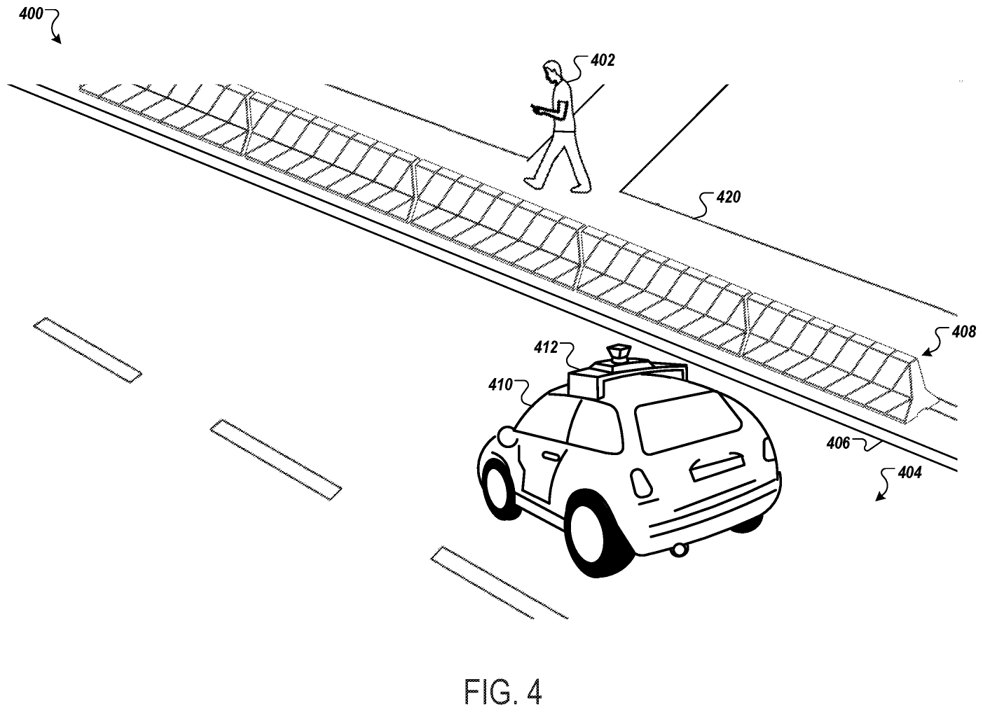

FIG. 4 is a diagram illustrating an example environment 400. The environment 400 includes a pedestrian 402, a road 404, a sidewalk 420, and a barrier 408 (e.g., a concrete barrier) between the sidewalk 420 and the road 404. The road 404 can include one or more markers, such as a road line 406 that marks an edge of the road 404.

A vehicle 410 is navigating through the environment 400 using an on-board system 412. The vehicle 410 can be a fully autonomous vehicle that determines and executes fully-autonomous driving decisions in order to navigate through the environment 400. The vehicle 410 can also be a semi-autonomous vehicle that uses predictions to aid a human driver. For example, the vehicle 410 can autonomously apply the brakes if a prediction indicates that a human driver is about to collide with an object in the environment 400, e.g., the barrier 408 and/or the pedestrian 402 shown in a surfel map of the environment 400. In some implementations, the vehicle 410 is the vehicle 102 shown in FIG. 1 and described above.

The on-board system 412 can include one or more sensor subsystems. The sensor subsystems can include a combination of components that receive reflections of electromagnetic radiation, e.g., lidar systems that detect reflections of laser light, radar systems that detect reflections of radio waves, and camera systems that detect reflections of visible light. The vehicle 410 is illustrated as an automobile, but the on-board system 412 can be located on-board any appropriate vehicle type. In some implementations, the on-board system 412 is the on-board system 110 shown in FIG. 1 and described above.

The sensor data generated by a given sensor of the on-board system 412 generally indicates a distance, a direction, and an intensity of reflected radiation. For example, a sensor of the on-board system 412 can transmit one or more pulses of electromagnetic radiation in a particular direction and can measure the intensity of any reflections as well as the time that the reflection was received. A distance can be computed by determining how long it took between a pulse and its corresponding reflection. The sensor can continually sweep a particular space in angle, azimuth, or both. Sweeping in azimuth, for example, can allow a sensor to detect multiple objects along the same line of sight.

The sensor subsystems of the on-board system 412 or other components of the vehicle 410 can also classify groups of one or more raw sensor measurements from one or more sensors as being measures of an object of a particular type. A group of sensor measurements can be represented in any of a variety of ways, depending on the kinds of sensor measurements that are being captured. For example, each group of raw laser sensor measurements can be represented as a three-dimensional point cloud, with each point having an intensity and a position. In some implementations, the position is represented as a range and elevation pair. Each group of camera sensor measurements can be represented as an image patch, e.g., an RGB image patch.

Once sensor subsystems of the on-board system 412 classify one or more groups of raw sensor measurements as being measures of a respective object of a particular type, the sensor subsystems of the on-board system 412 can compile the raw sensor measurements into a set of raw sensor data, and send the raw data to an environment prediction system, e.g., the environment prediction system 130 shown in FIG. 1.

The on-board system 412 can store a global surfel map, e.g., the global surfel map 145 shown in FIG. 1 and described above. The global surfel map can be an existing surfel map that has been generated by combining sensor data captured by multiple vehicles navigating through the real world. A portion of the global surfel map can correspond to the environment 400, e.g., previously generated by combining sensor data captured by one or more vehicles had navigated through the environment 400. As an example, this global surfel map can include an indication of the road 404, the road 404's markers including the road line 406, and the barrier 408.

Each surfel in the global surfel map can have associated data that encodes multiple classes of semantic information for the surfel. For example, for each of the classes of semantic information, the surfel map can have one or more labels characterizing a prediction for the surfel corresponding to the class, where each label has a corresponding probability. As a particular example, each surfel of the global surfel map can have multiple labels, with associated probabilities, predicting the type of the object characterized by the surfel, e.g. “concrete barrier” with probability 0.8, “road” with probability 0.82, and “road line” with probability 0.91.

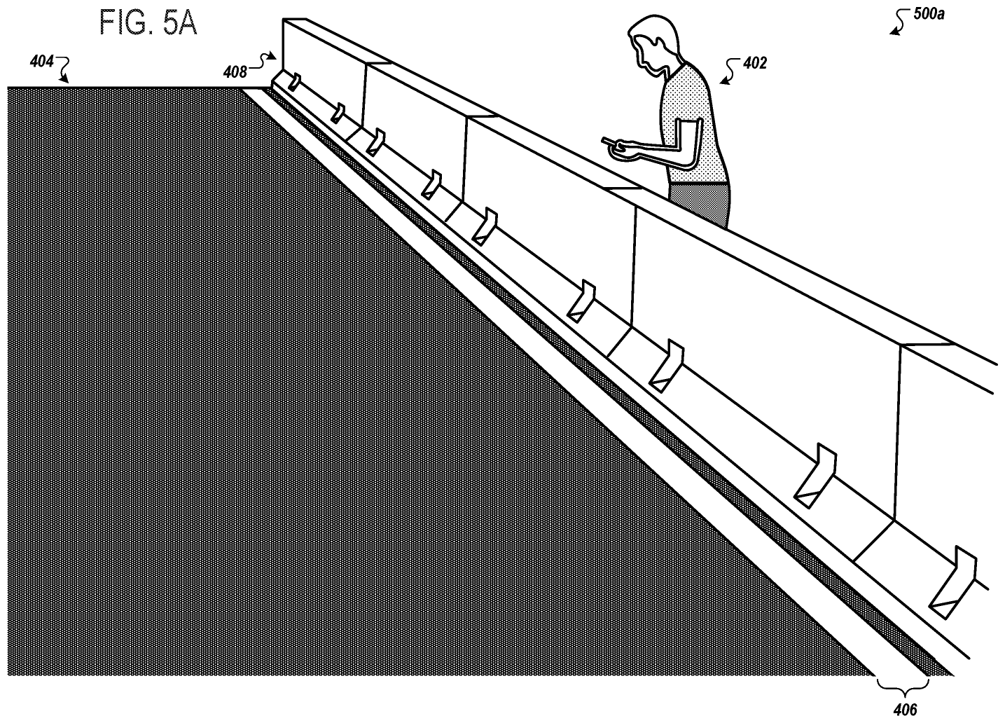

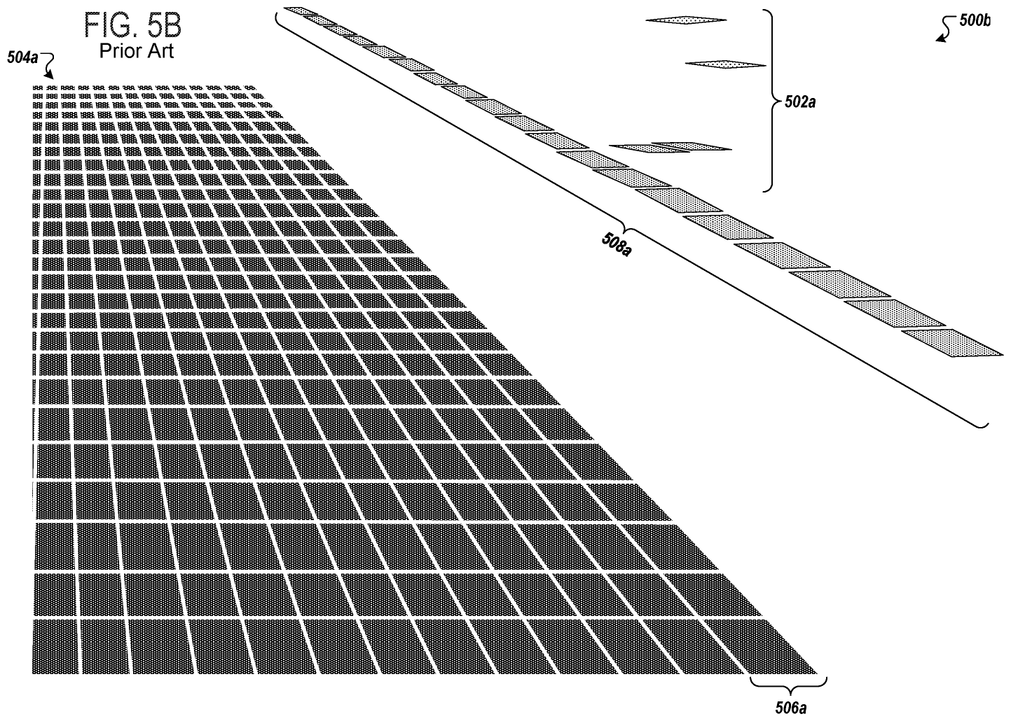

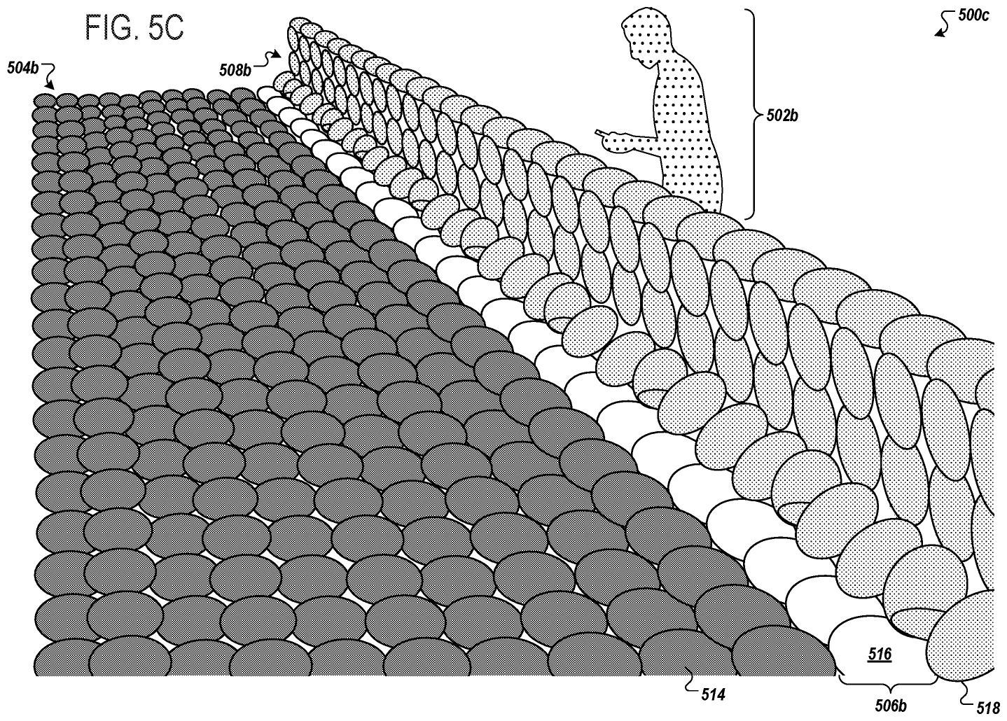

The environment prediction system 130 shown in FIG. 1 can receive the global surfel map and combine it with the raw sensor data collected using the on-board system 412 to generate an environment prediction for the environment 400. The environment prediction can include data that characterizes a prediction for the current state of the environment 400, including predictions for an object or surface at one or more locations in the environment 400. For example, as will be described in more detail with respect to FIG. 5C, the environment prediction can indicate for example that (i) the pedestrian 402 is headed in a direction towards the road 404, (ii) the pedestrian 402 is located behind the barrier 408 (e.g., that the barrier 408 is located between the pedestrian 402 and the road 404), and/or (ii) the pedestrian 402 will be prevented or sufficiently discouraged from entering the road 404 due to the barrier 408.

The raw sensor data might show that the environment through which the vehicle 410 is navigating has changed. In some cases, the changes might be large and discontinuous, e.g., if a new building has been constructed or a road has been closed for construction since the last time the portion of the global surfel map corresponding to the environment 400 has been updated. As an example, the barrier 408 may be newly added such that the global surfel map did not contain an indication of the barrier 408. In some other cases, the changes might be small and continuous, e.g., if a bush grew by an inch or a leaning pole increased its tilt. In either case, the raw sensor data can capture these changes to the world, and the environment prediction system 130 shown in FIG. 1 can use the raw sensor data to update the data characterizing the environment 400 stored in the global surfel map to reflect these changes in the environment prediction for the environment 400.

In some implementations, certain changes in the environment 400 as indicated by the raw sensor data are not used to update the data characterizing the environment 400 stored in the global surfel map. For example, temporary objects such as pedestrians, animals, bikes, vehicles, or the like may can be identified and intentionally not be added to the global surfel map due to their high likelihood of moving to different locations over time.

For one or more objects represented in the global surfel map, the environment prediction system 130 shown in FIG. 1 can use the raw sensor data to determine a probability that a given object is currently in the environment 400. In some implementations, the environment prediction system 130 can use a Bayesian model to generate the predictions of which objects are currently in the environment 400, where the data in the global surfel map is treated as a prior distribution for the state of the environment 400, and the raw sensor data is an observation of the environment 400. The environment prediction system 130 can perform a Bayesian update to generate a posterior belief of the state of the environment 400, and include this posterior belief in the environment prediction. In some implementations, the raw sensor data also has a probability distribution for each object detected by the sensor subsystem of the on-board system 412 describing a confidence that the object is in the environment 400 at the corresponding location; in some other implementations, the raw sensor data includes detected objects with no corresponding probability distribution.

For example, if the global surfel map includes a representation of a particular object (e.g., the barrier 408), and the raw sensor data includes a strong detection of the particular object in the same location in the environment 400, then the environment prediction can include a prediction that the object is in the location with high probability, e.g. 0.95 or 0.99. If the global surfel map does not include the particular object (e.g., the pedestrian 402), but the raw sensor data includes a strong detection of the particular object in the environment 400, then the environment prediction might include a prediction with moderate uncertainty that the object is in the location indicated by the raw sensor data, e.g. predict that the object is at the location with probability of 0.8 or 0.7. If the global surfel map does include the particular object, but the raw sensor data does not include a detection of the object at the corresponding location, or includes only a weak detection of the object, then the environment prediction might include a prediction that has high uncertainty, e.g. assigning a 0.6 or 0.5 probability that the object is present.

That is, the environment prediction system 130 shown in FIG. 1 might assign the same or more confidence to the correctness of the sensor data than to the correctness of the global surfel map. This might be true for objects that are determined to be temporary, e.g., pedestrians, animals, vehicles, or the like. Additionally or alternatively, the environment prediction system 130 shown might assign more confidence to the correctness of the global surfel map than to the correctness of the raw sensor data. This might be true for objects that are determined to be permanent, e.g., roads, road markers, barriers, trees, road signs, sidewalks, or the like. In either case, the environment prediction system 130 does not treat the raw sensor data or the global surfel map as a ground-truth, but rather associates uncertainty with both in order to combine them. Approaching each input in a probabilistic manner can generate a more accurate environment prediction, as the raw sensor data might have errors, e.g. if the sensors in the sensor subsystems of the on-board system 412 are miscalibrated, and the global surfel map might have errors, e.g. if the state of the environment 400 has changed.

In some implementations, the environment prediction can also include a prediction for each class of semantic information for each object in the environment. For example, the environment prediction system 130 shown in FIG. 1 can use a Bayesian model to update the associated data of each surfel in the global surfel map using the raw sensor data in order to generate a prediction for each semantic class and for each object in the environment 400. For each particular object represented in the global surfel map, the environment prediction system 130 can use the existing labels of semantic information of the surfels corresponding to the particular object as a prior distribution for the true labels for the particular object. For example, as will be described in more detail with respect to FIG. 5C, the on-board system 412 can assign a high confidence to surfels in the global surfel map that are already labeled as corresponding to the barrier 408 if the raw sensor data indicates that the barrier 408 is still present. The environment prediction system 130 can then update each prior using the raw sensor data to generate posterior labels and associated probabilities for each class of semantic information for the particular object. In some such implementations, the raw sensor data also has a probability distribution of labels for each semantic class for each object detected by the sensor subsystem of the on-board system 412; in some other implementations, the raw sensor data has a single label for each semantic class for each detected object.

As an example, where a particular surfel of the global surfel map characterizes the barrier 408 with probability 0.8 and the sidewalk 420 with probability 0.2, if the sensor subsystems of the on-board system 412 detect the barrier 408 at the same location in the environment 400 with high probability, then the Bayesian update performed by the environment prediction system 130 shown in FIG. 1 might generate new labels indicating that the object is the barrier 408 with probability 0.85 and the sidewalk 420 with probability 0.15. The new labels and associated probabilities for the object are added to the environment prediction.

With respect to FIG. 1, the environment prediction system 130 can provide the environment prediction to the planning subsystem 150, which can use the environment prediction to make autonomous driving decisions for the vehicle 410, e.g., generating a planned trajectory for the vehicle 410 through the environment 400.

As an example, the environment prediction(s) outputted by the environment prediction system 130 shown in FIG. 1 can indicate the current state of the environment 400. For example, the sensor data can indicate that an area in the environment 400 corresponding to the pedestrian 402 is unexpected. Specifically, the sensor data can indicate that the area of the environment 400 corresponding to the pedestrian 402 does not match that of a stored global surfel map, e.g., due to laser detections obtained using the on-board system 412 not matching expected detections (e.g., expected surface distances and/or angles of object(s) in the environment 400) based on the global surfel map and/or images obtained using the on-board system 412 not matching an expected view (e.g., expected colors, shapes, sizes, etc. of object(s) in the environment 400) based on the global surfel map. For example, sensor data can indicate that laser detections directed towards the area of the environment 400 corresponding to the pedestrian 402 indicate that an object is closer than expected. Specifically, the global surfel map can indicate that the laser light directed toward the area should contact grass at a range of first distances based on a group of surfels in the global map corresponding to the grass and being located in positions that are within the range of first distances of the vehicle 410. However, the sensor data can indicate that laser light directed towards the area instead contacted an object at a range of second distances that are closer than is closer than the range of first distances to the vehicle 410. Based on this, the output of the environment prediction system 130 can provide that an unexpected object (e.g., the pedestrian 402) is located in the environment 400.

The output of the environment prediction system 130 shown in FIG. 1 can indicate that the unexpected object (e.g., the pedestrian 402) is a temporary object. For example, the environment prediction system 130 can determine that the unexpected object (e.g., the pedestrian 402) is a temporary object by based on one or more of the sensor data indicating that the temporary object (e.g., the pedestrian 402) is moving or has moved a threshold distance, based on how recently the global surfel map was updated (e.g., if update was made recently by another vehicle traveling through the environment 400, then it is unlikely that a new permanent object has been added to the environment 400), based on image recognition determining that the unexpected object (e.g., the pedestrian 402) is a person or another temporary object, etc.

The environment prediction(s) outputted by the environment prediction system 130 shown in FIG. 1 can indicate, for example, events occurring in the environment 400. These events can include one or more of the movement of one or more objects, a direction of movement of one or more objects, a speed of one or more objects, an acceleration of one or more objects, a trajectory of one or more objects (e.g., based on the direction of movement, speed, and/or acceleration of the one or more objects), a determination that a path of travel of the vehicle 410 (e.g., trajectory of the vehicle) will cross a trajectory of one or more moving objects such that contact between the vehicle 410 and the one or more moving objects meets a threshold likelihood (e.g., greater than 0.1, 0.2, 0.3, etc.), or a determination that a path of travel of the vehicle 410 can result in the vehicle 410 contacting one or more stationary objects.

As an example, the environment prediction(s) can indicate a trajectory for the pedestrian 402. The trajectory for the pedestrian 402 may be such that the on-board system 412 anticipates that the pedestrian 402 will be brought into the path of travel of the vehicle 410 if the pedestrian 402 continues their current direction of movement and speed of movement. However, the environment prediction(s) can also indicate that the trajectory of the pedestrian 402 first encounters the barrier 408 prior to the path of travel of the vehicle 410. The on-board system 412 can determine that the trajectory of the pedestrian 402 will not continue past the barrier 408, e.g., that the barrier 408 will prevent or discourage the pedestrian 402 from walking into the road 404. This determination can be an environment prediction by the environment prediction system 130. This determination by the on-board system 412 (e.g., by the environment prediction system 130) can be based, in part, on a subset of surfels of the global surfel map or an updated global surfel map (e.g., updated using the sensor data) being (i) labelled as corresponding to the barrier 408, and/or (ii) having a high confidence of corresponding to the barrier 408 (e.g., greater than 0.8, 0.85, 0.9, etc.). The subset of surfels can be a grouping of surfels that are located between the path of travel of the vehicle 410 and a current location of the pedestrian 402 (e.g., as indicated by the sensor data), and that contact the pedestrian 402's trajectory and/or are near the pedestrian 402's trajectory (e.g., within 0.5, 1.0, or 1.5 meters).

The on-board system 412 (e.g., the environment prediction system 130) can use the sensor data, such as laser detections and image data, to determine a trajectory for the pedestrian 402. For example, the on-board system 412 can collect sensor data over a period of time and can use the sensor data of this period of time to determine one or more of a direction of movement of the pedestrian 402 in the environment 400, a speed that the pedestrian 402 is moving at (e.g., average speed of the pedestrian 402 in the period of time), an acceleration of the pedestrian 402 (e.g., average acceleration of the pedestrian 402 in the period of time), etc. This information can be provided to the environment prediction system 130. The environment prediction system 130 can use the information to determine a trajectory for the pedestrian 402. The trajectory for the pedestrian 402 can indicate the likely future positions of the pedestrian 402 (e.g., if they continue traveling in the same direction, at the same average speed, at the same average acceleration, etc.). The trajectory for the pedestrian 402 can also indicate times that the pedestrian 402 is likely to reach various positions along the trajectory.

The determination that the barrier 408 will prevent or discourage the pedestrian 402 from walking into the road 404 by the on-board system 412 (e.g., by the environment prediction system 130) can be based on one or more additional factors. These other factors can include one or more of the confidence in the on-board system 412, the confidence in one or more sensors of the on-board system 412, the dimensions of one or more objects, the uniformity of one or more objects (e.g., if there are holes in the barrier 408, if there are open sections of the barrier 408, etc.), or other labels attached to surfels corresponding to the one or more objects (e.g., indication that an object is made of concrete, indication that an object is made of metal, indication that an object is made of plastic, etc.). For example, the on-board system 412 can determine that the barrier 408 will prevent or discourage the pedestrian 402 from walking into the road 404 based on the subset of surfels corresponding to the barrier 408 indicating a sufficient confidence in the barrier 408 being at the identified location (e.g., greater than 0.8, 0.85, 0.9, etc.) or a sufficient confidence in a portion of the barrier 408 being at a location corresponding to the trajectory of the pedestrian 402, indicating that a height of the barrier 408 meets a threshold height (e.g., threshold height to assume that a person or animal will not cross a barrier of 3.0 feet, 3.5 feet, 4 feet, etc.) or that a height of the portion of the barrier 408 corresponding to the pedestrian 402's trajectory meets a threshold height, and indicating that barrier 408 is sufficiently uniform (e.g., the barrier 408 does not have any openings that are large enough to permit a person to travel through) or that the portion of the barrier 408 corresponding to the pedestrian 402's trajectory is sufficiently uniform.

Continuing with this example, with respect to FIG. 1, the environment prediction system 130 can provide the environment prediction that the barrier 408 will prevent or discourage the pedestrian 402 from walking into the road 404 by the on-board system 412 to the planning subsystem 150, which can use the environment prediction to make autonomous driving decisions for the vehicle 410. Here, the output of the planning subsystem 150 can provide for no changes to the vehicle 410's current path of travel and speed, e.g., since there is sufficient confidence that the barrier 408 will prevent or discourage the pedestrian 402 from traveling along their current trajectory into the road 404. Specifically, the output of the planning subsystem 150 can provide one or more of that the brakes of the vehicle 410 should not be applied, that the vehicle 410 should remain in the right lane, that power should continue to be applied to the driving wheels of the vehicle 410, or that the vehicle 410 should not take one or more evasive maneuvers.

However, as an example, if the environment prediction system 130 provides environment prediction(s) that indicate one or more of that their insufficient confidence in the location of the barrier 408 (e.g., confidence below 0.9, 0.85, 0.8, etc.), that the height of the barrier 408 does not meet a threshold height, that there is an opening in the barrier 408 that is sufficiently large such as to allow persons to travel through or sufficiently large so as to fail at discouraging persons from traveling through, or that the barrier 408 can be moved by the pedestrian 402 (e.g., based on the barrier 408 or a portion of the barrier 408 being made out of lightweight material such as plastic) or that the barrier 408 appears as if it can be moved by the pedestrian 402 (e.g., if the barrier 408 appears to be a light plastic barrier, then the barrier 408 may fail to discourage the pedestrian 402 from attempting to move the barrier 408), then the output of the planning subsystem 150 can provide for one or more changes to the vehicle 410's current path of travel and speed. For example, the output of the planning subsystem 150 can provide one or more of that the vehicle 410 should be steered towards the left lane of the road 404, that brakes of the vehicle 410 should be applied, that power to the driving wheels of the vehicle 410 should be reduced or cut off, or that the vehicle 410 should take one or more evasive maneuvers. Additionally or alternatively, the planning subsystem 150 can provide that power to the driving wheels of the vehicle 410 should be increased, e.g., in order to move the vehicle 410's trajectory ahead of the trajectory of the pedestrian 402 such that the two trajectories do not cross.

In some implementations, the raw sensor data collected by the on-board system 412 can be used, e.g., by environment prediction system 130 shown in FIG. 1, to determine a likelihood of an object continuing to travel along an identified trajectory. For example, with respect to the pedestrian 402, the on-board system 412 may determine that the pedestrian 402 is distracted based on determining from the raw sensor data that the pedestrian 402 is looking down, is looking at her phone, is wearing headphones, etc. The on-board system 412 (e.g., through the environment prediction system 130) can use this information along with other information, such as a height of the barrier 408, to determine that there is a sufficiently high likelihood of the pedestrian 402 entering the road 404 (e.g., by falling over the barrier 408 if its height is low enough) as a result of their distraction. Accordingly, the output of the planning subsystem 150 can provide one or more of that the vehicle 410 should be steered towards the left lane of the road 404, that brakes of the vehicle 410 should be applied, that power to the driving wheels of the vehicle 410 should be reduced or cut off, or that the vehicle 410 should take one or more evasive maneuvers.

FIG. 5A is a diagram illustrating an example visible view 500a of the environment 400. The visible view 500a can be the visible view of the environment 400 from the perspective of the on-board system 412 of the vehicle 410.

As shown, the visible view 500a of the environment 400 includes the road 404, the road line 406, the barrier 408, and the pedestrian 402 walking towards the road 404.

FIG. 5B is a diagram illustrating an example 2.5-dimensional map 500b of the environment 400.

Some vehicles use a two-dimensional or a 2.5-dimensional map to represent characteristics of the operating environment, such as the environment 400. A two-dimensional map associates each location, e.g., as given by latitude and longitude, with some properties, e.g., whether the location is a road, or a building, or an obstacle. A 2.5-dimensional map additionally associates a single elevation with each location. However, such 2.5-dimensional maps are problematic for representing three-dimensional features of an operating environment that might in reality have multiple elevations. For example, overpasses, tunnels, trees, and lamp posts all have multiple meaningful elevations within a single latitude/longitude location on a map.

As shown, the 2.5-dimensional map 500b has difficulty presenting three-dimensional feature of an operating environments as well as difficulty conveying other information. Notably, 2.5-dimensional maps such as the 2.5-dimensional map 500b fail to represent surfaces that are vertical (e.g., ninety degrees with respect to a horizontal plane), nearly vertical, or, in some cases, sufficiently angled (e.g., greater than 45 degree angle with respect to a horizontal plane, greater than 60 degrees with respect to a horizontal plane, greater than 80 degrees with respect to a horizontal plane, etc.). For example, the barrier 408 shown in FIGS. 4-5A is depicted by a representation 508a in the 2.5-dimensional map 500b. As shown, with respect to the barrier 408, the 2.5-dimensional map 500b is limited to capturing the horizontal or nearly horizontal surfaces of the barrier 408, which make up the representation 508a. The representation 508a fails to convey whether there is any material between the representation 508a and a representation 504a of the road 404.

As an example, if the on-board system 412 were to rely on the 2.5-dimensional map 500b, the on-board system 412 would be unable to determine if the barrier 408 is sufficient to prevent or discourage the pedestrian 402 from entering the road 404 based on the representation 508a of the barrier 408. Accordingly, the on-board system 412 may determine, as a result, to take one or more evasive maneuvers based on the incorrect determination that the barrier 408 will not prevent or will not discourage the pedestrian 402 from entering the road 404. These maneuvers are undesirable when they are not necessary as they can be unsettling to the passengers of the vehicle 410, could trigger undesirable reactions from drivers of other vehicles on the road 404, could startle the pedestrian 402 or other persons nearby, could potentially be dangerous, could result on more wear on the vehicle 410, etc. Accordingly, as will come to light with respect to FIG. 5C, a benefit provided by the on-board system 412 using a surfel map such as the surfel map 500c described below with respect to FIG. 5C, is that amount of unnecessary maneuvers of the vehicle 410 can be reduced. This can have the beneficial results of providing greater comfort to the passengers of the vehicle 410, can reduce wear experienced by the vehicle 410 (e.g., reduce brake wear, reduce tire wear, reduce wear on the engine due to fewer hard accelerations, etc.), can improve the safety for the passengers of the vehicle 410 and for others traveling along roads or near roads (e.g., due to less unexpected driving maneuvers being performed by the vehicle 410), etc.

Similarly, representations of objects in 2.5-dimensional maps such as the 2.5-dimensional map 500b may not otherwise be adequately represented such as to allow for accurate identification, and/or tracking. For example, a representation 502a for the pedestrian 402 is lacking to the point where it could make it difficult or impossible to accurately identify the object as a pedestrian. Similarly, e.g., in the case where the pedestrian 402 is identified beforehand based on one or more visible images, the representation 502a for the pedestrian 402 could prevent accurate tracking of the pedestrian 402 through the environment 400, prevent accurate identification of a trajectory of the pedestrian 402, and/or prevent the on-board system 412 from making other determinations with sufficient accuracy (e.g., a speed of the pedestrian 402, an acceleration of the pedestrian 402, a determination that the pedestrian 402 is distracted, a determination that the pedestrian 402 is looking down, a determination that the pedestrian 402 is looking at her cell phone or is on her cell phone, a determination that the pedestrian 402 is wearing headphones, etc.).

The 2.5-dimensional map 500b can also have difficulty conveying other information. For example, the 2.5-dimensional maps such as the 2.5-dimensional map 500b apply a color or shading to the detected surfaces based on the detected elevation of those surfaces. However, when this is done, other information of the environment 400 is potentially lost. For example, the 2.5-dimensional map 500b presents a first shading for the representation 504a of the road 404 including a representation 506a of the road line 406, a second shading for the representation 508a of the barrier 408, a third shading for a portion of the representation 502a of the pedestrian 402, and a fourth shading for a second portion of the representation 502a of the pedestrian 402. Each of these shading can correspond to a different elevation of the detected surfaces in the environment 400. However, an issue with this is that the representation 506a of the road line 406 becomes indistinguishable from the rest of the representation 504a of the road. Another issue is that this can lead to an object appearing to be multiple or separate objects in its 2.5-dimensional map representation. For example, the representation 502a of the pedestrian 402 appears as two or more different objects due to the 2.5-dimensional map presenting different surfaces of the pedestrian 402 with different shades due to the differences in elevation of those surfaces, as well as due to the failure of 2.5-dimensional map 500b in conveying the vertical or near vertical surfaces in the environment 400 which results in a disconnect between the different detected surfaces of the pedestrian 402.

For the reasons mentioned above, it may be difficult for the on-board system 412 shown in FIG. 4 to make predictions and/or make predictions accurately based on the 2.5-dimensional map 500b. For example, it may be difficult or impossible for the on-board system 412 to predict (e.g., through the environment prediction system 130) that the pedestrian 402 is behind the barrier 408 (e.g., as opposed to being in front of it and already in the road 404), that the pedestrian 402 cannot travel underneath the barrier 408, that the barrier 408 is made of a material that can prevent the pedestrian 402 from moving it or discourage the pedestrian 402 from attempting to move it, etc.

FIG. 5C is a diagram illustrating an example surfel map 500c of the environment 400. The diagram of FIG. 5C can also illustrate example sensor data collected from the environment 400.

The surfel map 500c can be a global surfel map. With respect to FIG. 4, the surfel map 500c may be stored on the on-board system 412 or may be accessed by the on-board system 412. The surfel map 500c may have been generated prior to the vehicle 410 entering the environment 400. For example, the surfel map 500c can be generated offline using collected sensor data, such as sensor data collected by one or more autonomous vehicles.

Each surfel in the surfel map 500c is represented by a disk, and defined by three coordinates (latitude, longitude, and altitude), that identify a position of the surfel in a common coordinate system of the environment 400 and by a normal vector that identifies an orientation of the surfel. For example, each volume element (voxel) can be defined to be the disk that extends some radius, e.g. 1, 10, 25, or 100 centimeters, around the coordinate (latitude, longitude, and altitude). In some other implementations, the surfels can be represented as other two-dimensional shapes, e.g. ellipsoids, squares, rectangles, etc.

The surfel map 500c can include a first group of surfels 504b that represent the road 404 of the environment 400, a second group of surfels 506b (e.g., that can be a subset of this first group of surfels 504b) that represent the road line 406 of the environment 400, and a third group of surfels 508b that represent the barrier 408 of the environment 400.

As shown, the diagram of FIG. 5C can also illustrate example sensor data collected from the environment 400. For example, with respect to FIG. 4, sensor data such as laser detections and/or images collected by the on-board system 412 are displayed alongside the surfel map 500c. As an example, the sensor data includes a collection of laser detections 502b. The collection of laser detections 502b can correspond to the pedestrian 402. The collection of laser detections 502b can be a collection of laser detections that did not match a global surfel map, e.g., did not match the expected distances and angles of surfaces as indicated by the surfel map 500c.

Each surfel in the surfel map 500c has associated data characterizing semantic information for the surfel. For example, as discussed above with respect to FIG. 1, for each of multiple classes of semantic information, the surfel map 500c can have one or more labels characterizing a prediction for the surfel corresponding to the class, where each label has a corresponding probability. As a particular example, each surfel can have multiple labels, with associated probabilities, predicting the type of the object characterized by the surfel. As another particular example, each surfel can have multiple labels, with associated probabilities, predicting the permanence of the object characterized by the surfel; for example, a “permanent” label might have a high associated probability for surfels characterizing buildings, while the “temporary” label might have a low probability for surfels characterizing vegetation. Other classes of semantic information can include a color, reflectivity, or opacity of the object characterized by the surfel.

For example, the surfel map 500c includes a road surfel 514 that characterizes a portion of the road 404 shown in FIG. 4. The road surfel 514 might have labels predicted (e.g., by the on-board system 412) that the type of the object characterized by the road surfel 514 is “road” with probability 0.95 and “road marker” with a probability of 0.05. Because roads are generally permanent objects, the “permanent” label for the road surfel 514 might be 0.98. The road surfel 514 might have color labels identifying the color of the road 404 as “black” with probability 0.95 and “grey” with probability 0.05. Because the road 404 is completely opaque and reflects little light, an opacity label of the road surfel 514 might identify that the road 404 is “opaque” with probability 0.99 and a reflectivity label of the road surfel 514 might identify that the road 404 is “not reflective” with probability 0.95.

As another example, the surfel map 500c includes a road marker surfel 516 that characterizes a portion of the road 404 corresponding to the road line 406 shown in FIG. 4. The road marker surfel 516 might have labels predicted (e.g., by the on-board system 412) that the type of the object characterized by the road marker surfel 516 is “road marker” with probability 0.95, “road” with a probability of 0.98, and “sidewalk” with a probability of 0.02. Because road markers are relatively permanent objects, the “permanent” label for the road marker surfel 516 might be 0.90. The road marker surfel 516 might have color labels identifying the color of the road line 406 as “white” with probability 0.95 and “grey” with probability 0.05. Because the road line 406 is completely opaque and reflects some light, an opacity label of the road marker surfel 516 might identify that the road line 406 is “opaque” with probability 0.99 and a reflectivity label of the road marker surfel 516 might predict that the road 404 is “reflective” with probability 0.90.

As shown, the surfel map 500c can convey more information and more detailed information when compared to the 2.5-dimensional map 500b shown in FIG. 5B. The on-board system 412 shown in FIG. 4 can use this additional information to make more accurate predictions, e.g., through the environment prediction system 130. As an example, the more detailed representation of the barrier 408 (e.g., the group of surfels 508b) in the surfel map 500c (e.g., as compared to the representation 508a of the barrier 408 in FIG. 5C) can allow the environment prediction system 130 to determine or determine with higher accuracy the dimensions and other characteristics of the barrier 408. In turn, the environment prediction system can predict and/or to predict with a higher confidence that the barrier 408 is sufficiently likely (e.g., greater than 0.95, 0.98, or 0.99 confidence) to prevent or discourage the pedestrian 402 from entering the road 404 (e.g., based on a height of the barrier 408, based on a material of the barrier 408, based on the size of openings in the barrier 408, based on a determination that pedestrians/animals cannot cross under the barrier 408, based on an identified direction of movement of the pedestrian 402, based on an identified speed of the pedestrian 402, based on an identified acceleration of the pedestrian 402, based on a trajectory of the pedestrian 402, etc.), that the barrier 408 is located between the pedestrian 402 and the road 404, that a portion of the barrier 408 that contacts (or is within a threshold distance from) the trajectory of the pedestrian 402 is sufficiently likely (e.g., greater than 0.95, 0.98, or 0.99 confidence) to prevent or discourage the pedestrian 402 from entering the road 404 (e.g., based on the height of the barrier 408, based on the consistency of the barrier 408, based on the barrier 408 being a concrete barrier, etc.), etc.

Specifically, unlike the 2.5-dimensional map 500b, the surfel map 500c can convey that the barrier 408 includes surfaces (e.g., vertical surfaces, nearly vertical surfaces, angled surfaces, etc.) that will prevent or discourage the pedestrian 402 from traveling under the barrier 408, through the barrier 408, etc. Similarly, because the surfels in the group of surfels 508b can each be associated with a material (e.g., concrete due to the barrier 408 being made from concrete), the on-board system 412 (e.g., the environment prediction system 130) can use the surfel map 500c to determine that there is a very low likelihood (e.g., below 0.2, 0.1, 0.05, etc.) that the pedestrian will be able to purposefully or unintentionally move or break the barrier 408 if they contact it. The surfel map 500c can also be used to by the on-board system 412 to more confidently determine that the pedestrian 402 is behind the barrier 408 (e.g., when compared to the 2.5-dimensional map 500b shown in FIG. 5B). Additionally, unlike the 2.5-dimensional map 500b, the surfel map 500c can convey that the road line 406 is distinct from the rest of the road 404.

The on-board system 412 can store a global surfel map, such as the surfel map 500c or the global surfel map 145 shown in FIG. 1 and described above. The global surfel map can be an existing surfel map that has been generated by combining sensor data captured by multiple vehicles navigating through the real world. The global surfel map or a portion of the global surfel map can correspond to the environment 400, e.g., previously generated by combining sensor data captured by one or more vehicles had navigated through the environment 400. As an example, this global surfel map can include an indication of the road 404, the road 404's markers including the road line 406, and the barrier 408.

Each surfel in the surfel map 500c (e.g., the global surfel map) can have associated data that encodes multiple classes of semantic information for the surfel. For example, for each of the classes of semantic information, the surfel map can have one or more labels characterizing a prediction for the surfel corresponding to the class, where each label has a corresponding probability. The surfels of the global surfel map can have a semantic label that corresponds to the object that it represents. Each of the labels attached to the surfels may have a corresponding probability. As a particular example, a first surfel of the global surfel map may have an attached label of “concrete barrier” with probability 0.95 and a second surfel of the global surfel map may have an attached label of “road” with probability 0.93. Additionally or alternatively, one or more of the surfels of the global surfel map can have multiple labels, with corresponding probabilities, predicting the type of the object characterized by the respective surfel. As a particular example, a given surfel of the global surfel map can have a first semantic label of “asphalt” with probability 0.95, a second semantic label of “road” with probability 0.94, and a third semantic label “road line” or “road paint” with probability 0.91.

The on-board system 412 can generate the representation of the environment 400 shown in FIG. 5C using the surfel map 500c (e.g., the global surfel map) and recently acquired sensor data. For example, the environment prediction system 130 shown in FIG. 1 can access the surfel map 500c (e.g., that includes a representation of the environment 400) stored on the on-board system 412 and can combine it with the raw sensor data collected using the sensors of the on-board system 412 to generate the representation of the environment 400 shown in FIG. 5C. The environment prediction can include data that characterizes a prediction for the current state of the environment 400, including predictions for an object or surface at one or more locations in the environment 400. For example, the environment prediction can indicate for example that (i) the pedestrian 402 is headed in a direction towards the road 404, (ii) the pedestrian 402 is located behind the barrier 408 (e.g., that the barrier 408 is located between the pedestrian 402 and the road 404), and/or (ii) the pedestrian 402 will be prevented or discouraged from entering the road 404 due to the barrier 408.

The raw sensor data might show that the environment through which the vehicle 410 is navigating has changed, e.g., when compared to a global surfel map (e.g., the surfel map 500c or an earlier version of the surfel map 500c). In some cases, the changes are large and discontinuous, e.g., if a new building has been constructed or a road has been closed for construction since the last time the portion of the global surfel map corresponding to the environment 400 has been updated. As an example, the barrier 408 may be newly added such that the global surfel map did not contain an indication of the barrier 408. In some other cases, the changes might be small and continuous, e.g., if a bush grew by an inch or a leaning pole increased its tilt. In some other cases, the changes might be small and discontinuous, e.g., if other vehicles are located in the environment 400, if one or more additional or less pedestrians are located in the environment 400, if one or more additional or less animals are located in the environment 400. In either case, the raw sensor data can capture these changes to the real world, and the environment prediction system 130 shown in FIG. 1 can use the raw sensor data to make environment predictions and/or to update the data characterizing the environment 400 stored in the global surfel map to reflect changes in the environment 400.

In some implementations, certain changes in the environment 400 as indicated by the raw sensor data are not used to update the data characterizing the environment 400 stored in the global surfel map (e.g., the surfel map 500c or an earlier version of the surfel map 500c). For example, temporary objects such as pedestrians, animals, bikes, vehicles, or the like may be identified and intentionally not be added to the global surfel map due to their high likelihood of moving to different locations over time. However, the on-board system 412 can use the sensor data to track these objects in the environment 400 as the vehicle 410 travels through the environment 400. When the sensor data indicates the presence of a new permanent object, the on-board system 412 may update the surfel map 500c to include the permanent object. Alternatively, a computer system (e.g., a centralized system that can communicate with one or more autonomous or semi-autonomous vehicles including the vehicle 410) can update the surfel map 500c after sensor data from one or more autonomous or semi-autonomous vehicles indicates the presence of a new permanent object in the environment 400. For example, the on-board system 412 may update the surfel map 500c to, for example, include the group of surfels 508b corresponding to the barrier 408 based on the barrier 408 being determined to be a permanent object, but might not update the surfel map 500c to account for the pedestrian 402 based on the pedestrian 402 being determined to be a temporary object.

The definitions of semantic labels, such as the labels “permanent” and/or “temporary”, can each have one or more definitions. The definition applied may be dependent on context. These definitions may be set by, for example, a system administrator. As a particular example, the label “permanent” may not necessarily have a single standard of longevity. For instance, as previously mentioned, the barrier 408 may be labeled as “permanent” despite it being a temporary barrier that will be eventually moved because the barrier 408 is critical for navigating the environment 400 and/or its position is unlikely to change in the immediate future. In some cases, an additional or alternative label may be attached to objects that are critical to navigation and/or are reliable (e.g., have positions that are unlikely to change in the immediate future) but that are known to be moved at some point in the future. For example, the label “semi-permanent” may be attached to the barrier 408 in place of “permanent” to indicate that the barrier 408 will likely be moved at some point in the future.

For one or more objects represented in the global surfel map (e.g., the surfel map 500c or an earlier version of the surfel map 500c), the environment prediction system 130 shown in FIG. 1 can use the raw sensor data to determine a probability that a given object is currently in the environment 400. In some implementations, the environment prediction system 130 can use a Bayesian model to generate the predictions of which objects are currently in the environment 400, where the data in the global surfel map is treated as a prior distribution for the state of the environment 400, and the raw sensor data is an observation of the environment 400. The environment prediction system 130 can perform a Bayesian update to generate a posterior belief of the state of the environment 400, and include this posterior belief in the environment prediction. In some implementations, the raw sensor data also has a probability distribution for each object detected by the sensor subsystem of the on-board system 412 describing a confidence that the object is in the environment 400 at the corresponding location; in some other implementations, the raw sensor data includes detected objects with no corresponding probability distribution.

As an example, the environment prediction system 130 shown in FIG. 1 can use the raw sensor data to determine a probability that the pedestrian 402 is currently in the environment 400. The probability can be compared to a threshold probability (e.g., 0.9, 0.85, 0.7, etc.) to determine if the pedestrian is on an opposite side of the barrier relative to the autonomous or semi-autonomous vehicle 410. In making this determination, the environment prediction system 130 can identify the pedestrian 402 as an object that does not exist in the global surfel map (e.g., which indicates that the object is likely a temporary object such as an animal, a pedestrian, a vehicle, etc.). In determining a probability that the pedestrian 402 is currently in the environment 400, the environment prediction system 130 can determine that the object is moving (e.g., which indicates that object is likely an animal, a pedestrian, a vehicle, etc.). In determining a probability that the pedestrian 402 is currently in the environment 400, the environment prediction system 130 can take into account one or more of the size of the object, the posture of the object, the speed of the object, the acceleration of the object, the movement of the object (e.g., movement that rhythmic and/or coincides with changes to elevation of the object can indicate that the object is walking and is therefore a pedestrian or an animal, whereas movement that is constant and that does not coincide with changes to elevation can indicate that the object is a vehicle), etc. based on sensor data obtained using the on-board system 412. In determining a probability that the pedestrian 402 is currently in the environment 400, the environment prediction system 130 can perform other object recognition techniques such as facial recognition to determine that the object is a pedestrian. Based on these determinations, the environment prediction system 130 can determine that the probability that the pedestrian 402 is in the environment 400 is 0.98. The environment prediction system 130 can compare this probability with a threshold probability of 0.90 to determine that the pedestrian 402 is in the environment 400 (e.g., that the environment 400 includes a pedestrian, that the identified object in the environment 400 is a pedestrian, etc.).

As an example, the environment prediction system 130 shown in FIG. 1 can use the raw sensor data to determine a probability that the pedestrian 402 is on an opposite side of the barrier 408 relative to the vehicle 410 (e.g., the pedestrian 402 is behind the barrier 408). The probability can be compared to a threshold probability (e.g., 0.8, 0.7, 0.65, etc.) to determine if the pedestrian is located behind the barrier. In determining a probability that the pedestrian 402 is on an opposite side of the barrier 408 relative to the vehicle 410, the environment prediction system 130 can determine one or more of that the collection of laser detections 502b corresponding to the pedestrian 402 are not representing the entirety of the pedestrian 402, that a portion (e.g., the surfels of the group of surfels 508b corresponding to the barrier 408 that are closest to the collection of laser detections 502b) of the surfels in the group of surfels 508b are closer to a portion of the surfels in the group of surfels 504b than the collection of laser detections 502b, that all of the surfels in the group of surfels 508b are closer to the surfels in the group of surfels 504b than the collection of laser detections 502b, that a trajectory corresponding to the collection of laser detections 502b will result in the object corresponding to the collection of laser detections 502b (e.g., the pedestrian 402) coming into contact with the barrier 408 (e.g., as indicated by the group of surfels 508b) before coming into contact with the road 404 (e.g., as indicated by the group of surfels 504b), etc. Based on these determinations, the environment prediction system 130 can determine that the probability that the pedestrian 402 is on an opposite side of the barrier 408 relative to the vehicle 410 is 0.95. The environment prediction system 130 can compare this probability with a threshold probability of 0.85 to determine that the pedestrian 402 is on an opposite side of the barrier 408 relative to the vehicle 410.

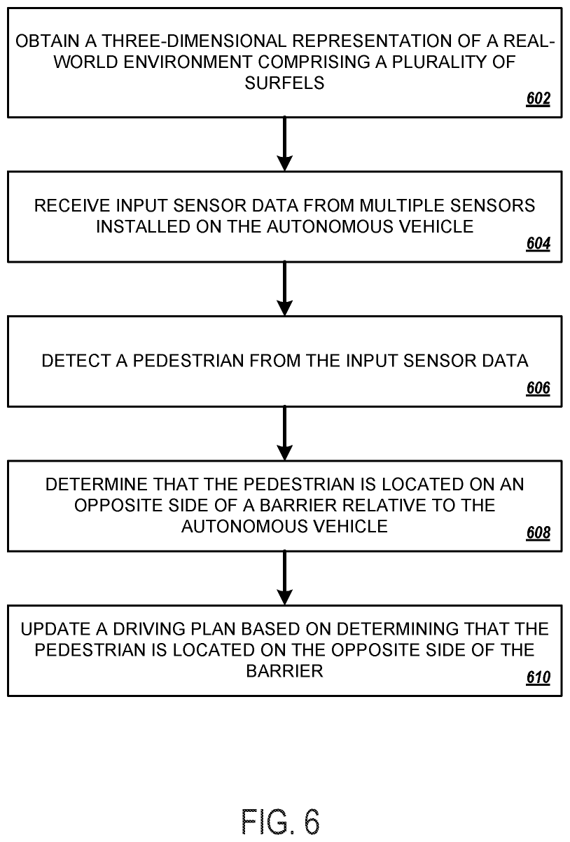

FIG. 6 is a flow diagram of an example process for adjusting navigation using a surfel map. The process can be performed, at least in part, using the on-board system 110 described herein with respect to FIG. 1. Some or all of the steps can be performed using a dedicated barrier logic subsystem, e.g., the barrier logic subsystem described with reference to FIG. 1, or by the on-board system 412 described herein with respect to FIG. 4. The example process will be described as being performed by a system of one or more computers.

The system obtains a three-dimensional representation of a real-world environment comprising a plurality of surfels (602). With respect to FIG. 4, the real-world environment can be the environment 400. The three-dimensional representation of the real-world environment can be a surfel map. For example, with respect to FIG. 1, the three-dimensional representation of the real-world environment can be the global surfel map 145 or another global surfel map for the environment 400. The global surfel map can be an existing surfel map that has been generated by combining sensor data captured by multiple vehicles navigating through the real-world environment. Similarly, with respect to FIG. 5C, the three-dimensional representation of the real-world environment can be the surfel map 500c or an earlier version of the surfel map 500c (e.g., without a representation of the pedestrian 402). With respect to FIG. 1, The on-board system 412 can store a global surfel map, e.g., the global surfel map 145 shown in FIG. 1 and described above. The global surfel map can be an existing surfel map that has been generated by combining sensor data captured by multiple vehicles navigating through the real world. The portion of the global surfel map can correspond to the environment 400, e.g., previously generated by combining sensor data captured by one or more vehicles had navigated through the environment 400. As an example, this global surfel map can include an indication of the road 404, the road 404's markers including the road line 406, and the barrier 408.

In some cases, each of the surfels of the plurality of surfels corresponds to a respective point of plurality of points in a three-dimensional space of the real-world environment. For example, with respect to FIG. 5C, each of the surfels of the plurality of surfels in the surfel map 500c can have spatial coordinates, e.g., (x,y,z) defining a particular position of the respective surfel in a three-dimensional coordinate system of the environment 400 shown in FIG. 4 or the visible view 500a shown in FIG. 5A of the environment 400. Additionally or alternatively, each of the surfels of the plurality of surfels in the surfel map 500c can have orientation coordinates, e.g., (pitch, yaw, roll) defining a particular orientation of the surface of the respective surfel. As another example, with respect to FIG. 5C, each of the surfels of the plurality of surfels in the surfel map 500c can have spatial coordinates that define the particular position of the respective surfel in a three-dimensional coordinate system (e.g., of the environment 400 shown in FIG. 4 or the visible view 500a shown in FIG. 5A of the environment 400) and a normal vector, e.g. a vector with a magnitude of 1, that defines the orientation of the surface of the respective surfel at the particular position.

The surfel map 500c depicts the environment 400 using multiple surfels. Each of the surfels can have one or more labels and corresponding confidences. The labels can, for example, identify the object that the surfel is conveying, identify a material that the object is made of, identify a permanence of the object, identify a color of the object (or a portion of the object), identify a opaqueness of the object (or a portion of the object), etc. With respect to FIG. 5C, a first group of surfels 504b can represent the road 404 of the environment 400. A second group of surfels 506b (e.g., that can be a subset of this first group of surfels 504b) can represent the road line 406 of the environment 400. A third group of surfels 508b can represent the barrier 408 of the environment 400.

The system receives input sensor data from multiple sensors installed on the autonomous vehicle (604). The input sensor data can include electromagnetic radiation. As an example, the input sensor data can include data collected by one or more of lidar systems that detect reflections of laser light, radar systems that detect reflections of radio waves, or camera systems that detect reflections of visible light. With respect to FIG. 1, the input sensor data can be the raw sensor measurements or the raw sensor data 125 compiled by the sensor subsystems 120. With respect to FIG. 4, the autonomous vehicle can be the vehicle 410. The on-board system 412 can include the sensors that collect the input sensor data. For example, the on-board system 412 can include one or more of a lidar system that detect reflections of laser light, a radar system that detect reflections of radio waves, or a camera system that detect reflections of visible light. The sensor data generated by a given sensor, e.g., of the on-board system 412, generally indicates a distance, a direction, and an intensity of reflected radiation. For example, a sensor of the on-board system 412 can transmit one or more pulses of electromagnetic radiation in a particular direction and can measure the intensity of any reflections as well as the time that the reflection was received. A distance can be computed by determining how long it took between a pulse and its corresponding reflection. The sensor can continually sweep a particular space in angle, azimuth, or both. Sweeping in azimuth, for example, can allow a sensor to detect multiple objects along the same line of sight.

The system detects an animate object from the input sensor data (606). An animate object can be a pedestrian, a bicyclist, an animal, drivers of vehicles, vehicles, etc. For example, with respect to FIG. 4, the animate object can be the pedestrian 402. The on-board system 412 can detect the pedestrian 402 in the environment 400 by comparing the input sensor data to the three-dimensional representation of the environment 400 (e.g., the global surfel map).

In some cases, in detecting an animate object from the input sensor data, the system uses the sensor data to make one or more determinations that can indicate the presence of an animate object in the real-world environment. For example, with respect to FIGS. 1 and 4, the environment prediction system 130 can use the input sensor data to determine a probability that the pedestrian 402 is currently in the environment 400. The probability can be compared to a threshold probability (e.g., 0.9, 0.85, 0.7, etc.) to determine if the pedestrian 402 is located on an opposite side of the barrier 408 relative to the vehicle 410. In detecting an animate object from the input sensor data, the environment prediction system 130 can identify the pedestrian 402 as an object that does not exist in the three-dimensional representation of the real-world environment (e.g., the global surfel map/the surfel map 500c shown in FIG. 5C) (e.g., which indicates that the object is likely a temporary object such as an animal, a pedestrian, a vehicle, etc.). In detecting an animate object from the input sensor data, the environment prediction system 130 can determine that the object is moving (e.g., which indicates that object is likely an animal, a pedestrian, a vehicle, etc.). In detecting an animate object from the input sensor data, the environment prediction system 130 can take into account one or more of the size of the object, the posture of the object, the speed of the object, the acceleration of the object, the movement of the object (e.g., movement that rhythmic and/or coincides with changes to elevation of the object can indicate that the object is walking and is therefore a pedestrian or an animal, whereas movement that is constant and that does not coincide with changes to elevation can indicate that the object is a vehicle). In detecting an animate object from the input sensor data, the environment prediction system 130 can perform other object recognition techniques such as facial recognition to determine that the object is an animate object such as a pedestrian.

Based on these determinations, the environment prediction system 130 can determine that the probability that the pedestrian 402 is in the environment 400 is 0.98. The environment prediction system 130 can compare this probability with a threshold probability of 0.90 to determine that the pedestrian 402 is in the environment 400 (e.g., that the environment 400 includes a pedestrian, that the identified object in the environment 400 is a pedestrian, etc.).

In some cases, the system labels one or more surfels in the three-dimensional representation of the real-world environment or updates the labels (or other information) of one or more surfels in the three-dimensional representation of the real-world environment. For example, with respect to FIGS. 1, 4, and 5C, in response to the sensor data verifying the positions of the surfels in the group of surfels 504b corresponding to the road 404, in the group of surfels 506b corresponding to the road line 406, and/or in the group of surfels 508b corresponding to the barrier 408b, the environment prediction system 130 can update the labels of the surfels to increase the probabilities associated with those labels. Specifically, if the laser detections and images collected using the on-board system 412 confirm that the surfel 516 has the correct position, correct orientation, correct color, etc., then the on-board system 412 can increase the probability that the surfel 516 is in the correction position from 0.8 to 0.9, the probability that the surfel 516 has the correct orientation from 0.85 to 0.9, that the surfel 516 has the correct color from 0.95 to 0.98, etc. The on-board system 412 can also use this sensor data to increase the probability associated with the permanent label associated with the road line 406 (e.g., can increase the probability from 0.85 to 0.95).

In some cases, detecting the animate object from the input sensor data includes performing object recognition using the input sensor data to identify the animate object in the real-world environment, or performing facial recognition using the input sensor data to identify the animate object in the real-world environment. For example, with respect to FIG. 4 and FIG. 5C, the on-board system 412 can apply object recognition or facial recognition to collected sensor data, such as image data and/or laser data, to identify animate objects in the environment 400. For example, the on-board system 412 may leverage one or more machine learning models that receive the collected sensor data as input and provide one or more outputs. The outputs may include an indication of unique objects present in the environment 400, and/or may include various confidences that correspond to different types of objects (e.g., person or animal; adult, child, small animal, or large animal; etc.). If the on-board system 412 identifies an object as most likely a person, the on-board system 412 may perform additional analysis of the collected sensor data corresponding to the identified object. For example, the on-board system 412 may proceed to perform facial recognition using the collected sensor data corresponding to the identified object to verify that it is a person.

In some cases, detecting the animate object from the input sensor data includes detecting that a group of surfels in the three-dimensional representation are blocked by an object. For example, with respect to FIG. 4 and FIG. 5C, the on-board system 412 can use collected sensor data and the surfel map 500c to identify areas in the environment 400 that do not match the surfel map 500c. The sensor data (e.g., laser detections, images, etc.) can indicate, for example, that one or more surfaces have positions that are closer or farther than expected, have orientations (e.g., one or more angles) that are different than expected, have attributes (e.g., color) that are different than expected, etc. Specifically, the collection of laser detections 502b can indicate the presence of an object that is in front of (e.g., is blocking) a group of surfels of the surfel map 500c, e.g., based on the collection of laser detections 502b being closer to the vehicle 410 than the expected surfels in the group of surfels. Based on this, the on-board system 412 can determine that an object is present in the environment 400 that was not in the surfel map 500c and that the object is blocking the group of surfels. The on-board system 412 can use the sensor data and/or other sensor data to confirm that the object is an animate object such as the pedestrian 402. For example, the on-board system 412 can collect sensor data over a period of time to determine that the object is moving and that the object is moving as a single object.

The system determines, from the input sensor data and the three-dimensional representation, that the animate object is located on an opposite side of a barrier relative to the autonomous vehicle (608). The barrier can include road barriers such as, for example, concrete barriers, fences, guardrails, etc. For example, with respect to FIG. 4, the barrier can be the barrier 408, a concrete barrier. The three-dimensional representation (e.g., the surfel map) can include a representation of the barrier. For example, with respect to FIG. 5C, the barrier 408 is represented by the group of surfels 508b.

In some cases, in determining that the animate object is located on an opposite side of the barrier relative to the autonomous vehicle, the system uses the input sensor data and the three-dimensional representation to determine a likelihood that the animate object is on an opposite side of the barrier relative to the autonomous vehicle. The likelihood (e.g., probability) can be compared to a threshold likelihood (e.g., 0.8, 0.7, 0.65, etc.) to determine if the animate object is located on an opposite side of the barrier relative to the autonomous vehicle. For example, with respect to FIGS. 1, 5, and 5C, the environment prediction system 130 shown in FIG. 1 can use the raw sensor data to determine a probability that the pedestrian 402 is on an opposite side of the barrier 408 relative to the vehicle 410. In making this determination, the environment prediction system 130 can determine one or more of that the collection of laser detections 502b corresponding to the pedestrian 402 are not representing the entirety of the pedestrian 402, that a portion (e.g., the surfels of the group of surfels 508b corresponding to the barrier 408 that are closest to the collection of laser detections 502b) of the surfels in the group of surfels 508b are closer to a portion of the surfels in the group of surfels 504b than the collection of laser detections 502b, that all of the surfels in the group of surfels 508b are closer to the surfels in the group of surfels 504b than the collection of laser detections 502b, that a trajectory corresponding to the collection of laser detections 502b will result in the pedestrian 402 coming into contact with the barrier 408 (e.g., as indicated by the group of surfels 508b) before coming into contact with the road (e.g., as indicated by the group of surfels 504b), etc. Based on these determinations, the environment prediction system 130 can determine that the probability that the pedestrian 402 is on an opposite side of the barrier 408 relative to the vehicle 410 is 0.95. The environment prediction system 130 can compare this probability with a threshold probability of 0.85 to determine that the pedestrian 402 is on an opposite side of the barrier 408 relative to the vehicle 410.

In some cases, determining a height of the barrier includes determining a height of the barrier at a location where the trajectory of the animate object intersects the barrier. For example, with respect to FIGS. 4 and 5C, the on-board system 412 can determine the surfels of the group of surfels 508b that contact the pedestrian 402's trajectory. The on-board system 412 can identify the coordinates of the surfels in the group of surfels 508b that contact the pedestrian 402's trajectory to identify a portion of the barrier 408 that the pedestrian 402 is likely to make contact with, e.g., can identify the x-coordinate and y-coordinate values of the contacted surfels. The on-board system 412 can then find the height of the barrier 408 at this portion of the barrier 408, e.g., by finding the surfel(s) in the group of surfels 508b that has x-coordinate and y-coordinate values that are the same or similar to the contacted surfels, and that has the largest z-coordinate value among the surfels in the group of surfels 508b with the same or similar x-coordinate and y-coordinate values.

In some cases, determining that the animate object is located on an opposite side of the barrier relative to the autonomous vehicle includes determining that a group of surfels that correspond to the barrier is located between a group of surfels that correspond to a roadway on which the autonomous vehicle is traveling and the detected location of the animate object (e.g., based on laser detections or other sensor data). For example, with respect to FIGS. 4 and 5C, the on-board system 412 can determine that barrier 408 is located between the road 404 and the pedestrian 402 based on a determination that the group of surfels 508b are located between the group of surfels 504b and the collection of laser detections 502b. This determination can be further based on the consistency of the group of surfels 508b, e.g., a determination from the group of surfels 508b that there are no openings in the barrier 408 that are sufficiently large so as to let someone through. The group of surfels that correspond to the barrier, and the group of surfels that correspond to the roadway are part of the three-dimensional representation. The autonomous vehicle can supplement the three-dimensional representation with sensor data. For example, the representation of the environment 400 in FIG. 5C includes the surfel map 500c that includes the group of surfels 508b that correspond to the barrier 408 and the group of surfels 504b that correspond to the road 404, and also depicts the collection of laser detections 502b that correspond to the pedestrian 402.

In some cases, determining that the animate object is located on an opposite side of the barrier relative to the autonomous vehicle includes determining that a group of surfels that correspond to the barrier are closer to a group of surfels that correspond to a roadway on which the autonomous vehicle is traveling than to a detected location of the animate object (e.g., based on laser detections or other sensor data). For example, with respect to FIGS. 4 and 5C, the on-board system 412 can use the surfel map 500c and the three-dimensional coordinates of the surfels in the surfel map 500c to determine that the group of surfels 508b are closer to the group of surfels 504b than to the collection of laser detections 502b that correspond to the pedestrian 402. Specifically, as an example, for a given y-coordinate value or range of y-coordinate values, the on-board system 412 can determine that each of the surfels in the group of surfels 508b that have y-coordinate values that match the set value or fall in the set range are closer (e.g., have a lower x-coordinate value) to a geometric center of the surfels in the group of surfels 504b that have y-coordinate values that match the set value or fall in the set range than each (or the majority) of the collection of laser detections 502b. The set value or range of values can be determined based on the collection of laser detections 502b (e.g., by finding the average y-coordinate value of each of the laser detection points in the collection of laser detections 502b) and/or on a trajectory of the pedestrian 402.

In some cases, determining that the animate object is located on an opposite side of the barrier relative to the autonomous vehicle includes identifying a group of surfels in the three-dimensional representation that correspond to the barrier. For example, with respect to FIGS. 4 and 5C, the on-board system 412 can retrieve the surfel map 500c (e.g., a global surfel map) and can identify surfels in the global surfel map that are classified/labelled as a barrier. These surfels can collectively form the group of surfels 508b.

In some cases, identifying the group of surfels in the three-dimensional representation that correspond to the barrier includes determining that the barrier is adjacent to a roadway that the autonomous vehicle is traveling on. For example, with respect to FIGS. 4 and 5C, the on-board system 412 can determine that the barrier 408 is a roadside barrier based on multiple surfels in the group of surfels 508b being adjacent to (e.g., contacting) surfels that are classified as a road or a road marker. Specifically, the on-board system 412 can determine that the barrier 408 is adjacent to the road 404 that the vehicle 410 is traveling on based on multiple surfels in the group of surfels 508b being adjacent to surfels in the group of surfels 506b which can include labels indicating that they represent the road line 406, and/or are part of the road 404.

In some cases, identifying the group of surfels in the three-dimensional representation that correspond to the barrier includes determining that the group of surfels correspond to a roadside barrier, a median barrier, a bridge barrier, a work zone barrier, or a fence. For example, with respect to FIGS. 4 and 5C, the on-board system 412 can retrieve a global surfel map and retrieve labels from the group of surfels 502. These labels can indicate, for example, that the barrier 408 is a roadside barrier, that the barrier 408 is made from concrete, that the barrier 408 is grey, etc. Alternatively (e.g., in the case where the barrier 408 is a new object in the environment 400), the on-board system 412 can use other information in the surfel map 500c to determine a type of barrier for the barrier 408. For example, the on-board system 412 can use the surfel map 500c to determine one or more of that one side of the barrier 408 is adjacent to a roadway, a height of the barrier 408, a color of the barrier 408, a reflectivity of the barrier 408, etc. Based on these one or more determinations, the on-board system 412 can determine that the barrier 408 is a concrete roadside barrier. The on-board system 412 can proceed to label each of the surfels in the group of surfels 508b as being a roadside barrier, and/or as being made of concrete.

In some cases, determining that the animate object is located on an opposite side of the barrier relative to the autonomous vehicle includes determining that a trajectory of the animate object intersects with a path of travel of the autonomous vehicle and with the barrier. For example, with respect to FIGS. 4 and 5C, the on-board system 412 can determine a trajectory for the pedestrian 402 from the sensor data including the collection of laser detections 502b, e.g., by using the sensor data to track the movements of the pedestrian 402 in the environment 400 over a time period. The on-board system 412 can determine that the pedestrian 402 is at risk of contacting the vehicle 410 based on the trajectory of the pedestrian 402 intersecting with a path of travel of the vehicle 410. However, the on-board system 412 can determine that the pedestrian 402 will first contact the barrier 408 based on the trajectory of the pedestrian 402 first contacting at least a portion of the barrier 408 (e.g., contacting one or more surfels of the group of surfels 508b in the surfel map 500c) prior to reaching the path of travel of the vehicle 410.

In some cases, the system determines that the animate object is unlikely to enter a roadway that the autonomous vehicle is traveling on due to a trajectory of the animate object intersecting the barrier. For example, with respect to FIG. 4 and FIG. 5C, the on-board system 412 can use the sensor data including the collection of laser detections 502b to identify a location of the pedestrian 402 and to determine a trajectory for the pedestrian 402. The on-board system 412 (e.g., the environment prediction system 130) can determine that the trajectory for the pedestrian 402 provides that the pedestrian 402 will contact the barrier 408, e.g., based on the trajectory for the pedestrian 402 contacting one or more of the surfels in the group of surfels 508b. Based on this, the on-board system 412 can determine that it is unlikely that the pedestrian 402 will enter the road 404 even if the trajectory of the pedestrian 402 directs the pedestrian 402 towards the road 404.

In some cases, determining that the animate object is unlikely to enter a roadway that the autonomous vehicle is traveling on includes determining that a likelihood of the animate object entering the roadway is below a threshold likelihood. For example, with respect to FIG. 4 and FIG. 5C, the on-board system 412 can the group of surfels 508b to determine and/or identify a height of the barrier 408, a confidence in the height of the barrier 408, a material that the barrier 408 is made out of, a confidence in the material that the barrier 408 is made of, a consistency of the barrier 408, a confidence in the consistency of the barrier 408, etc. The on-board system 412 can use this information to determine that the likelihood of the barrier 408 preventing or discouraging the pedestrian 402 from entering the road 404 is 0.92. The on-board system 412 can compare this likelihood to a threshold likelihood of 0.90 to determine that it is unlikely that the pedestrian 402 will enter the road 404.

In some cases, determining that the animate object is unlikely to enter a roadway that the autonomous vehicle is traveling on includes determining that the trajectory of the animate object intersects the barrier prior to a path of travel of the autonomous vehicle. For example, with respect to FIG. 4 and FIG. 5C, even if the on-board system 412 determines that a trajectory of the pedestrian 402 intersects with a path of travel of the vehicle 410 along the road 404, the on-board system 412 can determine that the pedestrian 402 is unlikely to enter the road 404 based on the trajectory of the pedestrian 402 contacting the barrier 408 (e.g., based on contacting one or more of the surfels of the group of surfels 508b in the surfel map 500c) prior to contacting the path of travel of the vehicle 410.

In some cases, the barrier is a barrier between two roads or two sides of the same roadway. The existence of the barrier and/or the characteristics of the barrier, as indicated by a surfel map, can be used by the on-board system 412 to predict the behavior of drivers of vehicles, of bicyclists, and autonomous or semi-autonomous vehicles on a first side of the road 404 when the vehicle 410 is traveling along a second side of the road 404 such that the barrier is located between the first side of the road 404 and the second side of the road 404. As an example, if a vehicle on the first side of the road 404 is merging or changing lanes such that its trajectory intersects the second side of the road 404 and/or a trajectory of the vehicle 410, the on-board system 412 may direct the vehicle 410 to increase acceleration and/or to change lanes from a left-most lane to a right-most lane if the surfel map indicates that there is no barrier between the first side of the road 404 and the second side of the road 404. However, if the surfel map indicates that there is a barrier between the first and second side of the road 404 (or a barrier with characteristics that are determined to sufficiently discourage or prevent vehicles from entering the second side of the road 404 from the first side of the road 404), then the on-board system 412 may refrain from performing any addition actions (e.g., refrain from modifying its current driving plan) despite the current trajectory of a vehicle on the first side of the road 404 intersecting with the second side of the road 404 and/or with a trajectory of the vehicle 410. This may be due to the on-board system 412 determining that there was a sufficiently low likelihood of the vehicle on the first side of the road 404 continuing to travel along its current trajectory as a result of determining that the barrier is sufficiently likely to discourage or prevent such travel.

The system updates a driving plan based on determining that the animate object is located on the opposite side of the barrier relative to the autonomous vehicle (610). Updating a driving plan can include updating the driving plan to include a determination to perform one or more actions with respect to the autonomous vehicle, or to avoid performing one or more actions with respect to the autonomous vehicle.

In some cases, the system computes a height of the barrier using one or more surfels in the plurality of surfels. For example, with respect to FIGS. 4 and 5C, the on-board system 412 can identify surfels in the three-dimensional representation (e.g., the surfel map 500c) that have been categorized as corresponding to the barrier 408, e.g., the group of surfels 508b. The on-board system 412 can analyze the group of surfels 508b to compute an approximate height of the barrier 408.

As an example, the on-board system 412 can use the group of surfels 508b to identify a top edge of the barrier 408 and a bottom edge of the barrier 408. The on-board system 412 can identify the top and bottom edge of the barrier 408 by identifying areas in the three-dimensional representation where the group of surfels 508b ends or transitions to surfels of other categories (e.g., surfels that have been labelled/categorized as “road”, “road marker”, “sidewalk”, “pedestrian”, “animal”, “sky,” “bush”, “tree”, etc.). For example, the on-board system 412 can identify a first row of surfels of the group of surfels 508b that represent the top of the barrier 408, and a second row of surfels of the group of surfels 508b that represents the bottom/base of the barrier 408. The on-board system 412 can determine that the first row of surfels and the second row of surfels both define edges of the barrier 408 by determining, for example, that each of the surfels in the respective rows of surfels are adjacent to a surfel with a different categorization (e.g., a categorization other than “barrier”) and/or are adjacent to empty space.

The on-board system 412 can determine that the first row of surfels represents the top of the barrier 408, and that the second row of surfels of the group of surfels 508b represents the bottom/base of the barrier 408 using the coordinates associated with the surfels in each of the rows. For example, the on-board system 412 can determine that the first row of surfels collectively has a z-coordinate value of 1.5 meters (e.g., by averaging the z-coordinate values of each of the surfels in the first row of surfels), and that the second row of surfels collectively has a z-coordinate value of 0.1 meters (e.g., by averaging the z-coordinate values of each of the surfels in the second row of surfels). From this, the on-board system 412 can conclude that the first row of surfels defines a top edge of the barrier 408 and that the second row of surfels (e.g., adjacent to the group of surfels 506b that represent the road line 406) defines a bottom edge of the barrier 408. The on-board system 412 can take the difference between the average height of the first row of surfels (e.g., 1.5 meters) and the average height of the second row of surfels (e.g., 0.1 meters) to compute the height of the barrier 408 (e.g., 1.4 meters).

In some cases, updating the driving plan includes updating the driving plan based on the height of the barrier. For example, as described in more detail below, the on-board system 412 shown in FIG. 12 may update a driving plan to apply the brakes of the vehicle 410 despite the pedestrian 402 being located on an opposite side of the barrier 408 relative to the vehicle 410 due to the barrier 408 having a height (e.g., 1.1 meters) below a threshold height (e.g., 1.3 meters). The barrier 408 being below the threshold height can indicate to the on-board system 412 (e.g., to the environment prediction system 130 shown in FIG. 1) that there is too great a risk of the pedestrian 402 crossing over the barrier 408, and, accordingly, that driving plan should be updated based on the assumption that the pedestrian 402 will cross over the barrier 408 into the road 404.

In some cases, updating the driving plan includes determining that the height of the barrier meets a threshold height, and, in response, maintaining a speed of the autonomous vehicle. For example, the on-board system 412 may compare the determined height of the barrier 408 (e.g., 1.4 meters) to a threshold height (e.g., 1.4 meters) to determine that the height of the barrier 408 meets the threshold height. The barrier 408 being below the threshold height can indicate to the on-board system 412 (e.g., to the environment prediction system 130 shown in FIG. 1) that there is too great a risk of the pedestrian 402 crossing over the barrier 408, and, accordingly, that driving plan should be updated based on the assumption that the pedestrian 402 will cross over the barrier 408 into the road 404.

In some cases, maintaining the speed of the autonomous vehicle includes evaluating a plurality of driving plans including a first driving plan, and rejecting the first driving plan and selecting a different driving plan of the plurality of driving plans. A first driving plan of the plurality of driving plans can specify engaging brakes of the autonomous vehicle or changing a direction of travel in response to detecting the animate object. Selecting a different driving plan of the plurality of driving plans can include selecting a driving plan that provides for refraining from engaging brakes of the autonomous vehicle, or maintaining a power output to the driving wheels of the autonomous vehicle. Additionally or alternatively, selecting a different driving plan of the plurality of driving plans can include selecting a driving plan that provides for maintaining a direction of travel of the autonomous vehicle. For example, with respect to FIGS. 1 and 4, the output of the environment prediction system 130 shown in FIG. 1 can indicate that the barrier 408 will prevent or discourage the pedestrian 402 from crossing into the road 404. This output can be provided to the planning subsystem 150 which, in turn, can update the driving plan of the vehicle 410 (or can select a driving plan form a plurality of stored driving plans) such that the speed of the vehicle 410 is maintained by maintaining the current power output to the driving wheels of the vehicle 410, and/or a direction of travel of the vehicle 410 is maintained by steering the vehicle 410 such that it continues to navigate the road 404 in the right lane.

In some cases, the system determines that the height of the barrier meets a threshold height. For example, the on-board system 412 may compare the determined height of the barrier 408 (e.g., 1.4 meters) to a threshold height (e.g., 1.4 meters) to determine that the height of the barrier 408 meets the threshold height. The barrier 408 meeting the threshold height can indicate to the on-board system 412 (e.g., to the environment prediction system 130 shown in FIG. 1) that there is little risk of the pedestrian 402 crossing over the barrier 408, and, accordingly, that driving plan should be updated (or a driving plan should be selected) based on the assumption that the barrier 408 will prevent or discourage the pedestrian 402 from crossing into the road 404 (e.g., a sufficient confidence that the barrier 408 will reduce the likelihood of the pedestrian 402 crossing into the road 404 to an acceptable risk level). Here, updating the driving plan based on the height of the barrier can include reducing a speed of the autonomous vehicle. Reducing the speed of the autonomous vehicle can include engaging brakes of the autonomous vehicle, or reducing a power output to the driving wheels of the autonomous vehicle. Additionally or alternatively, updating the driving plan based on the height of the barrier can include changing a direction of travel of the autonomous vehicle. Additionally or alternatively, updating the driving plan based on the height of the barrier can include increasing a speed of the autonomous vehicle. For example, with respect to FIGS. 1 and 4, the output of the environment prediction system 130 shown in FIG. 1 can indicate that there is a sufficiently great risk that the barrier 408 will not prevent or discourage the pedestrian 402 from crossing into the road 404. This output can be provided to the planning subsystem 150 which, in turn, can update the driving plan of the vehicle 410 such that the speed of the vehicle 410 is reduced by engaging the brakes of the vehicle 410 or reducing the power output to the driving wheels of the vehicle 410, and/or a direction of travel of the vehicle 410 is changed by steering the vehicle 410 to the left lane of the road 404.

Alternatively, the planning subsystem 150 can update the driving plan of the vehicle 410 based on the output such that the speed of the vehicle 410 is increased by increasing the power output to the driving wheels of the vehicle 410 (e.g., in a situation where the vehicle 410 would not be able to slow down quick enough, or it would be too dangerous to attempt such a slowdown), and/or a direction of travel of the vehicle 410 is changed by steering the vehicle 410 to the left lane of the road 404.

In some cases, the system determines a threshold height to be used for comparing to the height of the barrier. The threshold height can be dynamic in that it can be relative to the heights and/or sizes of one or more objects currently present in the real-world environment. Similarly, the threshold height can be dynamic in that it can be relative to classifications of objects such as classifications of pedestrians in the real-world environment (e.g., child, adult, adult male, adult female, etc.). For example, with respect to FIG. 4, the threshold height for the barrier 408 can be based on a determined height of the pedestrian 402 and/or a classification of the pedestrian 402. Specifically, the on-board system 412 may classify the pedestrian 402 as a child if the detected height of the pedestrian 402 is below a threshold height (e.g., less than 5 ft tall, less than 4 ft tall, etc.) or within a particular height range (e.g., between 3 ft and 5 ft tall). Similarly, the on-board system 412 may classify the pedestrian 402 as an adult if the detected height of the pedestrian 402 meets the threshold height (e.g., 4 ft tall or taller, 5 ft tall or taller, etc.) or is within a particular height range (e.g., between 5 ft and 8 ft tall).

With respect to FIG. 5C, the on-board system 412 can use the collection of laser detections 502b to estimate that the height of the pedestrian 402 is 2.0 meters (e.g., by taking the difference between the z-coordinate value of the laser detection in the collection of laser detections 502b with the greatest z-coordinate value to an average z-coordinate value for the sidewalk 420 using surfels of the surfel map 500c that represent the sidewalk 420). The threshold height can be calculated by multiplying the determined height of the object in the real-world environment by a constant value, such as 0.6, 0.7, 0.8, 1.0, 1.2, etc. The constant value selected can be based on, for example, one or more of the type of barrier (e.g., median barrier, roadside barrier such as a guardrail, bridge barrier, work zone barrier, or fence), a material that the barrier is made from (e.g., concrete, metal, wood, or plastic), a material that the barrier appears to be made from (e.g., appears to be metal but is actually plastic and thereby discourages pedestrians from attempting to move it), the object being a pedestrian versus an animal, the object being an adult pedestrian versus a child pedestrian (e.g., lower constant for an adult pedestrian due to an assumption that they are less likely to cross a given barrier), etc. For example, the on-board system 412 can use the determined height of 2.0 meters for the pedestrian 402 to determine that the constant 0.6 should be used (e.g., based on the pedestrian 402 being identified as an adult, the barrier 408 being a roadside barrier, and/or the barrier 408 being made from concrete), and, therefore, that the threshold height for the barrier 408 should be 1.2 meters.

In some cases, updating the driving plan includes updating the driving plan to perform one or more of the following actions: maintain a speed of the autonomous vehicle, increase a speed of the autonomous vehicle, reduce a speed of the autonomous vehicle, maintain a direction of travel of the autonomous vehicle, change a direction of travel of the autonomous vehicle, maintain a power output to driving wheels of the autonomous vehicle, increase power output to driving wheels of the autonomous vehicle, decrease power output to driving wheels of the autonomous vehicle, apply brakes of the autonomous vehicle, or refrain from applying brakes of the autonomous vehicle. For example, with respect to FIGS. 1 and 4, the planning subsystem 150 can use the output of the environment prediction system 130 to update a driving plan for the vehicle 410 to perform one or more of the following actions: maintain a speed of the autonomous vehicle, increase a speed of the autonomous vehicle, reduce a speed of the autonomous vehicle, maintain a direction of travel of the autonomous vehicle, change a direction of travel of the autonomous vehicle, maintain a power output to driving wheels of the autonomous vehicle, increase power output to driving wheels of the autonomous vehicle, decrease power output to driving wheels of the autonomous vehicle, apply brakes of the autonomous vehicle, or refrain from applying brakes of the autonomous vehicle.

In some cases, the system determines a likelihood that the barrier will prevent or discourage the animate object from traveling into a roadway on which the autonomous vehicle is traveling meets a threshold likelihood. The likelihood can be a probability. The threshold likelihood can be a threshold probability. For example, with respect to FIGS. 1 and 4, the environment prediction system 130 can receive sensor data of the environment 400 collected by the on-board system 412 as input. The environment prediction system 130 can output a probability of the whether the barrier 408 will prevent or discourage the pedestrian 402 from traveling into the road 404. The on-board system 412 can compare this probability with a threshold probability (e.g., 0.85, 0.9, 0.95, etc.). If the probability meets the threshold probability, the planning subsystem 150 can assume, for example, that the pedestrian 402 will not cross the barrier 408. Accordingly, the planning subsystem 150 can update the driving plan to maintain a direction of travel of the vehicle 410 and/or to maintain a speed of travel of the vehicle 410. If the probability does not meet the threshold probability, the planning subsystem 150 assumes, for example, that the pedestrian 402 will cross the barrier 408. Accordingly, the planning subsystem 150 can update the driving plan to change a direction of travel of the vehicle 410 and/or to reduce (or increase) a speed of travel of the vehicle 410.

In some cases, the system detecting multiple objects in the real-world environment based on the input sensor data, compares sensor data corresponding to the multiple objects to the three-dimensional representation to determine an object of the multiple objects that has a corresponding representation in the three-dimensional representation, and updates information corresponding to the representation of the object in the three-dimensional representation using sensor data of the input sensor data that corresponds to the object. For example, with respect to FIG. 4 and FIG. 5C, the on-board system 412 can use collected sensor data to identify multiple objects currently present in the environment 400 (e.g., using object recognition, facial recognition, etc.). Specifically, the on-board system 412 may identify the pedestrian 402 and the barrier 408. The on-board system 412 can proceed to compare these multiple objects with the surfel map 500c to determine a representation of one of the objects exists in the surfel map 500c. Specifically, the on-board system 412 can determine that the surfel map 500c includes a representation of the barrier 408 in the form of the group of surfels 508b and, optionally, determine that the surfel map 500c does not include a representation of the pedestrian 402. The on-board system 412 can proceed to update the group of surfels 508b (the representation of the barrier 408) using a subset of the collected sensor data that correspond to the barrier 408.

In some cases, updating information corresponding to the representation of the object in the three-dimensional representation includes applying a first weight to the sensor data of the input sensor data that corresponds to the object, applying a second weight that is greater than the first weight to the information corresponding to the representation of the object, generating new information corresponding to the representation of the object using the weighted sensor data and the weighted information, and replacing the information corresponding to the representation of the object with the new information corresponding to the representation of the object. Continuing with the previous example, the on-board system 412 may apply a first weight to the subset of the collected sensor data the corresponds to the barrier 408 (e.g., after the sensor data has been normalized and/or has otherwise converted to a usable format), and a second weight to the information corresponding to the group of surfels 508b (e.g., the surfel map 500c representation of the barrier 408). The information corresponding to the group of surfels 508b may include information that used to generate the information such as coordinate information that indicates the locations of the surfels that make up the group of surfels 508b, orientation information that indicates how the surfels that make up the group of surfels 508b are orientated, and/or color information that indicates how the surfels that make up the group of surfels 508b should be displayed. The information may additionally or alternatively include information that is associated with the surfels in the group of surfels 508b, such as, for example, tags (e.g., type of material tag, type of object tag, barrier tag, permanent tag, etc.) and confidences associated with the tags. The weight that the on-board system 412 applies to the prior knowledge (e.g., the information that corresponds to the group of surfels 508b) may be larger than the weight the on-board system 412 applies to the subset of the collected sensor data.

The on-board system 412 may proceed to generate new information using the weighted prior knowledge and the weighted subset of the collected sensor data, and replace the weighted prior knowledge with the new information. In replacing the weighted prior knowledge with the new information, the representation of the barrier 408 in the surfel map 500c may be updated (e.g., to reflect updated surfel locations, updated surfel colors, updated surfel orientations etc.).

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, off-the-shelf or custom-made parallel processing subsystems, e.g., a GPU or another kind of special-purpose processing subsystem. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

obtaining a three-dimensional representation of a real-world environment includes a plurality of surfels, wherein each of the surfels corresponds to a respective point of plurality of points in a three-dimensional space of the real-world environment;

receiving input sensor data from multiple sensors installed on the autonomous vehicle;

detecting an animate object from the input sensor data;

determining, from the input sensor data and the three-dimensional representation, that the animate object is located on an opposite side of a barrier relative to the autonomous vehicle; and

updating a driving plan based on determining that the animate object is located on the opposite side of the barrier.

Embodiment 2 is the method of embodiment 1, comprising computing a height of the barrier using one or more of surfels in the plurality of surfels,

wherein updating the driving plan comprises updating the driving plan based on the height of the barrier.

Embodiment 3 is the method of any one of embodiments 1 or 2, wherein updating the driving plan comprises:

determining that the height of the barrier meets a threshold height; and

in response, maintaining a speed of the autonomous vehicle.

Embodiment 4 is the method of any one of embodiments 1-3, wherein maintaining the speed of the autonomous vehicle comprises:

evaluating a plurality of driving plans, wherein a first driving plan of the plurality of driving plans specifies engaging brakes of the autonomous vehicle or changing a direction of travel in response to detecting the animate object; and

rejecting the first driving plan and selecting a different driving plan of the plurality of driving plans.

Embodiment 5 is the method of any one of embodiments 1-4, comprising determining a threshold height to compare to the height of the barrier, wherein the threshold height is based on the height of the animate object or a classification of the animate object.

Embodiment 6 is the method of embodiment 1-5, wherein detecting the animate object from the input sensor data comprises:

performing object recognition using the input sensor data to identify the animate object in the real-world environment; or

performing facial recognition using the input sensor data to identify the animate object in the real-world environment, wherein the animate object is a person.

Embodiment 7 is the method of any one of embodiments 1-6, wherein determining that the animate object is located behind the barrier comprises identifying a group of surfels in the three-dimensional representation that correspond to the barrier.

Embodiment 8 is the method of any one of embodiments 1-7, comprising determining that the animate object is unlikely to enter a roadway that the autonomous vehicle is traveling on due to a trajectory of the animate object intersecting the barrier.

Embodiment 9 is the method of any one of embodiments 1-8, wherein determining that the animate object is unlikely to enter a roadway that the autonomous vehicle is traveling on comprises determining that the trajectory of the animate object intersects the barrier prior to a path of travel of the autonomous vehicle.

Embodiment 10 is the method of any one of embodiments 1-9, wherein determining that the animate object is unlikely to enter a roadway that the autonomous vehicle is traveling on comprises determining that a likelihood of the animate object entering the roadway is below a threshold likelihood.

Embodiment 11 is the method of any one of embodiments 1-10, wherein updating the driving plan comprises updating the driving plan to perform one or more of the following actions: maintain a speed of the autonomous vehicle, increase a speed of the autonomous vehicle, reduce a speed of the autonomous vehicle, maintain a direction of travel of the autonomous vehicle, change a direction of travel of the autonomous vehicle, maintain a power output to driving wheels of the autonomous vehicle, increase power output to driving wheels of the autonomous vehicle, decrease power output to driving wheels of the autonomous vehicle, apply brakes of the autonomous vehicle, or refrain from applying brakes of the autonomous vehicle.

Embodiment 12 is the method of any one of embodiments 1-11, comprising determining a likelihood that the barrier will prevent or discourage the animate object from traveling into a roadway on which the autonomous vehicle is traveling meets a threshold probability.

Embodiment 13 is the method of any one of embodiments 1-12, wherein determining a probability that the barrier will prevent or discourage the animate object from traveling into the roadway comprises determining, from a group of surfels in the three-dimensional representation that correspond to the barrier, one or more of that an average height of the barrier meets a threshold height, a lowest height of the barrier meets a threshold height, any openings in the barrier are less than a threshold size, the barrier prevents persons or animals from traveling underneath the barrier, a material of the barrier is metal, a material of the barrier appears to be metal, a material of the barrier is concrete, a material of the barrier appears to be concrete, a material of the barrier is wood, or a material of the barrier appears to be wood.

Embodiment 14 is the method of any one of embodiments 1-13, wherein the surfels of the three-dimensional representation are two-dimensional objects that each have a size, an orientation, and a location in a three-dimensional space.

Embodiment 15 is the method of any one of embodiments 1-14, wherein the three-dimensional space is the three-dimensional representation.

Embodiment 16 is the method of any one of embodiments 1-15, wherein the surfels of the three-dimensional representation are circular or elliptical objects.

Embodiment 17 is the method of any one of embodiments 1-16, comprising:

based on the input sensor data, detecting multiple objects in the real-world environment;

comparing sensor data corresponding to the multiple objects to the three-dimensional representation to determine an object of the multiple objects that has a corresponding representation in the three-dimensional representation; and

updating information corresponding to the representation of the object in the three-dimensional representation using sensor data of the input sensor data that corresponds to the object.

Embodiment 18 is the method of any one of embodiments 1-17, wherein updating information corresponding to the representation of the object in the three-dimensional representation comprises:

applying a first weight to the sensor data of the input sensor data that corresponds to the object;

applying a second weight that is greater than the first weight to the information corresponding to the representation of the object;

generating new information corresponding to the representation of the object using the weighted sensor data and the weighted information; and

replacing the information corresponding to the representation of the object with the new information corresponding to the representation of the object.

Embodiment 19 is a system comprising: one or more computers and one or more storage devices storing instructions that are operable, when executed by the one or more computers, to cause the one or more computers to perform the method of any one of embodiments 1 to 18.

Embodiment 20 is a computer storage medium encoded with a computer program, the program comprising instructions that are operable, when executed by data processing apparatus, to cause the data processing apparatus to perform the method of any one of embodiments 1 to 18. While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A computer-implemented method for controlling an autonomous vehicle comprising:
obtaining a three-dimensional representation of a real-world environment comprising a plurality of surfels, wherein each of the surfels corresponds to a respective point of plurality of points in a three-dimensional space of the real-world environment;
receiving input sensor data from multiple sensors installed on the autonomous vehicle;
detecting an animate object from the input sensor data;
determining, from the input sensor data and the three-dimensional representation, that the animate object is located on an opposite side of a barrier relative to the autonomous vehicle; and
updating a driving plan based on determining that the animate object is located on the opposite side of the barrier.

2. The method of claim 1, comprising computing a height of the barrier using one or more of surfels in the plurality of surfels,
wherein updating the driving plan comprises updating the driving plan based on the height of the barrier.

3. The method of claim 2, wherein updating the driving plan comprises:
determining that the height of the barrier meets a threshold height; and
in response, maintaining a speed of the autonomous vehicle.

4. The method of claim 3, wherein maintaining the speed of the autonomous vehicle comprises:
evaluating a plurality of driving plans, wherein a first driving plan of the plurality of driving plans specifies engaging brakes of the autonomous vehicle or changing a direction of travel in response to detecting the animate object; and
rejecting the first driving plan and selecting a different driving plan of the plurality of driving plans.

5. The method of claim 2, comprising determining a threshold height to compare to the height of the barrier, wherein the threshold height is based on the height of the animate object or a classification of the animate object.

6. The method claim 1, wherein detecting the animate object from the input sensor data comprises:
performing object recognition using the input sensor data to identify the animate object in the real-world environment; or
performing facial recognition using the input sensor data to identify the animate object in the real-world environment, wherein the animate object is a person.

7. The method of claim 1, wherein determining that the animate object is located behind the barrier comprises identifying a group of surfels in the three-dimensional representation that correspond to the barrier.

8. The method of claim 1, comprising determining that the animate object is unlikely to enter a roadway that the autonomous vehicle is traveling on due to a trajectory of the animate object intersecting the barrier.

9. The method of claim 8, wherein determining that the animate object is unlikely to enter a roadway that the autonomous vehicle is traveling on comprises determining that the trajectory of the animate object intersects the barrier prior to a path of travel of the autonomous vehicle.

10. The method of claim 8, wherein determining that the animate object is unlikely to enter a roadway that the autonomous vehicle is traveling on comprises determining that a likelihood of the animate object entering the roadway is below a threshold likelihood.

11. The method of claim 1, wherein updating the driving plan comprises updating the driving plan to perform one or more of the following actions: maintain a speed of the autonomous vehicle, increase a speed of the autonomous vehicle, reduce a speed of the autonomous vehicle, maintain a direction of travel of the autonomous vehicle, change a direction of travel of the autonomous vehicle, maintain a power output to driving wheels of the autonomous vehicle, increase power output to driving wheels of the autonomous vehicle, decrease power output to driving wheels of the autonomous vehicle, apply brakes of the autonomous vehicle, or refrain from applying brakes of the autonomous vehicle.

12. The method of claim 1, comprising determining a likelihood that the barrier will prevent or discourage the animate object from traveling into a roadway on which the autonomous vehicle is traveling meets a threshold probability.

13. The method of claim 12, wherein determining a probability that the barrier will prevent or discourage the animate object from traveling into the roadway comprises determining, from a group of surfels in the three-dimensional representation that correspond to the barrier, one or more of that an average height of the barrier meets a threshold height, a lowest height of the barrier meets a threshold height, any openings in the barrier are less than a threshold size, the barrier prevents persons or animals from traveling underneath the barrier, a material of the barrier is metal, a material of the barrier appears to be metal, a material of the barrier is concrete, a material of the barrier appears to be concrete, a material of the barrier is wood, or a material of the barrier appears to be wood.

14. The method of claim 1, wherein the surfels of the three-dimensional representation are two-dimensional objects that each have a size, an orientation, and a location in a three-dimensional space.

15. The method of claim 14, wherein the three-dimensional space is the three-dimensional representation.

16. The method of claim 14, wherein the surfels of the three-dimensional representation are circular or elliptical objects.

17. The method of claim 1, comprising:
based on the input sensor data, detecting multiple objects in the real-world environment;
comparing sensor data corresponding to the multiple objects to the three-dimensional representation to determine an object of the multiple objects that has a corresponding representation in the three-dimensional representation; and
updating information corresponding to the representation of the object in the three-dimensional representation using sensor data of the input sensor data that corresponds to the object.

18. The method of claim 17, wherein updating information corresponding to the representation of the object in the three-dimensional representation comprises:
applying a first weight to the sensor data of the input sensor data that corresponds to the object;
applying a second weight that is greater than the first weight to the information corresponding to the representation of the object;
generating new information corresponding to the representation of the object using the weighted sensor data and the weighted information; and
replacing the information corresponding to the representation of the object with the new information corresponding to the representation of the object.

19. A system comprising:
one or more computers; and
one or more computer-readable media storing instructions that, when executed, cause the one or more computers to perform operations comprising:
obtaining a three-dimensional representation of a real-world environment comprising a plurality of surfels, wherein each of the surfels corresponds to a respective point of plurality of points in a three-dimensional space of the real-world environment;
receiving input sensor data from multiple sensors installed on the autonomous vehicle;
detecting an animate object from the input sensor data;
determining, from the input sensor data and the three-dimensional representation, that the animate object is located on an opposite side of a barrier relative to the autonomous vehicle; and
updating a driving plan based on determining that the animate object is located on the opposite side of the barrier.

20. One or more non-transitory computer-readable media storing instructions that, when executed by one or more computers, cause the one or more computers to perform operations comprising:
obtaining a three-dimensional representation of a real-world environment comprising a plurality of surfels, wherein each of the surfels corresponds to a respective point of plurality of points in a three-dimensional space of the real-world environment;
receiving input sensor data from multiple sensors installed on the autonomous vehicle;
detecting an animate object from the input sensor data;
determining, from the input sensor data and the three-dimensional representation, that the animate object is located on an opposite side of a barrier relative to the autonomous vehicle; and
updating a driving plan based on determining that the animate object is located on the opposite side of the barrier.
